(19) United States
(12) Patent Application Publication
(10) Pub. No.: US 2025/0094268 A1
(43) Pub. Date: Mar. 20, 2025

(54) Performance And Power Efficient Link Error Recovery In Inter-chiplet Communication

(71) Applicant: QUALCOMM Incorporated, San Diego, CA (US)

(72) Inventors: Santhosh Reddy AKAVARAM, Hyderabad (IN); Prakhar SRIVASTAVA, Lucknow (IN); Sridhar ANUMALA, Hyderabad (IN); Chintalapati BHARATH SAI VARMA, Hyderabad (IN)

(21) Appl. No.: 18/468,479

(22) Filed: Sep. 15, 2023

(51) Int. Cl. G06F 11/07; G06F 13/42

(52) U.S. Cl. CPC G06F 11/079; G06F 11/0745; G06F 13/42

(57) ABSTRACT

Various embodiments include methods and devices for efficiently recovering from errors that occur in part but not all of a universal chiplet interconnect express (UCIe) link for chiplets of a computing device. Various embodiments may include identifying a first part of a UCIe link in which an error has occurred, and training the first part of the UCIe link in which the error has occurred while maintaining active a second part of the UCIe link in which no error has occurred.

### BACKGROUND

The Universal Chiplet Interconnect Express (UCIe) specification provides for a UCIe link to undergo training on exit from an error state (“TRAINERROR” of the UCIe link training status and state machine (LTSSM)) or from a low power state. The error state may be due to an error in a UCIe link main band or a UCIe link sideband. Training the UCIe link requires initializing the UCIe link sideband and initializing and training the UCIe link mainband.

### SUMMARY

Various aspects provide methods include methods and apparatuses for implementing such methods for managing errors occurring in parts of a universal chiplet interconnect express (UCIe) link for chiplets of a computing device. Various aspects may include identifying a first part of a UCIe link in which an error has occurred, training the first part of the UCIe link in which the error has occurred, and maintaining active a second part of the UCIe link in which no error has occurred while training the first part of the UCIe link in which the error has occurred.

In some aspects, the first part of the UCIe link may be a sideband, the second part of the UCIe link may be a mainband, and identifying the first part of a UCIe link in which the error has occurred may include identifying a timeout for a sideband message, setting a UCIe link error recovery structure with a value configured to indicate to the computing device an occurrence of the error in the sideband in response to identifying the timeout for the sideband message, and reading the value configured to indicate to the computing device the occurrence of the error in the sideband from the error recovery structure.

In some aspects, the first part of the UCIe link may be a sideband, the second part of the UCIe link may be a mainband, training the first part of the UCIe link in which the error has occurred may include toggling power to the sideband, and transitioning from a sideband initialization state directly to a link initialization state, and maintaining active the second part of the UCIe link in which no error has occurred while training the first part of the UCIe link in which the error has occurred may include maintaining power to the mainband while training the sideband.

In some aspects, the first part of the UCIe link may be a mainband, the second part of the UCIe link may be a sideband, and identifying the first part of a UCIe link in which the error has occurred may include identifying a handshake request for entering an error state, setting a UCIe link error recovery structure with a value configured to indicate to the computing device an occurrence of the error in the mainband in response to identifying the handshake request for entering the error state, and reading the value configured to indicate to the computing device the occurrence of the error in the mainband from the error recovery structure.

In some aspects, the first part of the UCIe link may be a mainband, the second part of the UCIe link may be a sideband, training the first part of the UCIe link in which the error has occurred may include toggling power to the mainband, and transitioning from a reset state directly to a mainband initialization state, and maintaining active the second part of the UCIe link in which no error has occurred while training the first part of the UCIe link in which the error has occurred may include maintaining power to the sideband while training the mainband.

In some aspects, the first part of the UCIe link may be a mainband and a sideband, the second part of the UCIe link may be no part of the UCIe link, and identifying the first part of a UCIe link in which the error has occurred may include identifying a handshake request for entering an error state, identifying a timeout for a handshake response for entering the error state, setting a UCIe link error recovery structure with a value configured to indicate to the computing device an occurrence of the error in the mainband and the sideband in response to identifying the handshake request and identifying the timeout for the handshake response for entering the error state, and reading the value configured to indicate to the computing device the occurrence of the error in the mainband and the sideband from the error recovery structure.

In some aspects, the first part of the UCIe link may be a mainband and a sideband, the second part of the UCIe link may be no part of the UCIe link, and training the first part of the UCIe link in which the error has occurred may include toggling power to the mainband and to the sideband, and transitioning from a sideband initialization to a mainband initialization state.

Further aspects include a computing device including a memory and a processing system configured to perform operations of any of the methods summarized above. Further aspects include a non-transitory processor-readable storage medium having stored thereon processor-executable software instructions configured to cause one or more processors of a processing system to perform operations of any of the methods summarized above. Further aspects include a computing device having means for accomplishing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example processing system suitable for implementing various embodiments.

FIG. 2 is a component block diagram illustrating an example of a universal chiplet interconnect express (UCIe) system of the computing device suitable for implementing various embodiments.

FIG. 3 is a component block diagram illustrating an example of a chiplet configured for UCIe suitable for implementing various embodiments.

FIG. 4 is a component block and information structure diagram illustrating an example of a UCIe link error recovery structure suitable for implementing various embodiments.

FIG. 5 is an information structure diagram illustrating an example information structure for implementing UCIe link error recovery according to an embodiment.

FIG. 6 is a process flow diagram illustrating an example method for implementing UCIe link error recovery according to an embodiment.

FIGS. 7A and 7B are process flow diagram illustrating example methods for implementing UCIe link error recovery for a sideband according to an embodiment.

FIG. 8 is a graph flow diagram illustrating an example UCIe link training status and state machine (LTSSM) for UCIe link error recovery for the sideband suitable for implementing various embodiments.

FIGS. 9A and 9B are process flow diagram illustrating example methods for implementing UCIe link error recovery for a mainband according to an embodiment.

FIG. 10 is a graph flow diagram illustrating an example UCIe LTSSM for UCIe link error recovery for the mainband suitable for implementing various embodiments.

FIGS. 11A and 11B are process flow diagram illustrating example methods for implementing UCIe link error recovery for a sideband and a mainband according to an embodiment.

FIG. 12 is a graph flow diagram illustrating an example UCIe LTSSM for UCIe link error recovery for the sideband and the mainband suitable for implementing various embodiments.

FIG. 13 is a component block diagram illustrating an example mobile computing device suitable for implementing various embodiments.

FIG. 14 is a component block diagram illustrating an example mobile computing device suitable for implementing various embodiments.

FIG. 15 is a component block diagram illustrating an example server suitable for implementing various embodiments.

FIGS. 16A-16C are component block diagrams illustrating an example embedded vehicle computing system suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and processing systems and/or computing devices implementing such methods, for implementing performance-efficient and power-efficient universal chiplet interconnect express (UCIe) link error recovery in inter-chiplet communications. Various embodiment methods of UCIe link error recovery may include identifying one or more parts of a UCIe link, such as a sideband and/or a mainband of a lane of a UCIe link, in which an error has occurred. In response to identifying the one or more parts of a UCIe link in which an error has occurred, the one or more parts may be trained as part of a recovery from the error. During training of a part of the UCIe link in which an error has occurred, power may be maintained for another part of the UCIe link in which an error has not occurred. For example, for an identified sideband in which an error has occurred, power may be maintained for a mainband of the UCIe link during training of the sideband. As another example, for an identified mainband in which an error has occurred, power may be maintained for a sideband of the UCIe link during training of the mainband.

The term “computing device” is used herein to refer to stationary computing devices including personal computers, desktop computers, all-in-one computers, workstations, super computers, mainframe computers, embedded computers (such as in vehicles and other larger systems), computing systems within or configured for use in vehicles, servers, multimedia computers, and game consoles. The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a processing system including one or more programmable processors.

The term “chiplet” is used herein to describe an integrated circuit that is communicably connected to at least one other chiplet in a package via a die-to-die interconnect scheme, such as UCIe. Each chiplet may be configured for specific a function(s). For example, each chiplet may be designed for data storage functions, signal processing functions, input/output (I/O) functions, etc. Multiple chiplets may be configured as a processing system and/or system-on-chip (SoC). The chiplets of a package may be connected to a shared semiconductor substrate and to each other via a shared semiconductor interposer, such as in a 2.5D package. The chiplets may be stacked such that at least one chiplet may be connected to the shared semiconductor substrate and/or the shared semiconductor interposer through another chiplet, such as in a 3D package. Stacked chiplets may be connected to one or more other chiplets via the shared semiconductor interposer. The chiplets may be single module (or interface) configurations and/or multi-module (or multi-interface) configurations, such as 2 or 4 modules (or interfaces). The chiplets may be configured as standard (low bandwidth) and/or advanced (high bandwidth) packages.

Various embodiments are described in terms of code, e.g., processor-executable instructions, for ease and clarity of explanation, but may be similarly applicable to any data, e.g., code, program data, or other information stored in memory. The terms “code,” “data,” and “information” are used interchangeably herein and are not intended to limit the scope of the claims and descriptions to the types of code, data, or information used as examples in describing various embodiments.

The Universal Chiplet Interconnect Express (UCIe) specification provides for a UCIe link to undergo training on exit from an error state (“TRAINERROR” of the UCIe link training status and state machine (LTSSM)) or from a low power state. The error state may be due to an error in a UCIe link mainband or a UCIe link sideband. Training the UCIe link requires initializing the UCIe link sideband and initializing and training the UCIe link mainband. For example, UCIe link training follows the LTSSM states from a reset state (“RESET”) to a sideband initialization state (“SBINIT”) to a mainband initialization state (“MBINIT”) to a mainband training state (“MBTRAIN”) to a link initialization state (“LINKINIT”) to an active state (“ACTIVE”). Initializing and/or training the sideband and the mainband when an error has occurred for only one of the sideband or the mainband is inefficient from a power consumption and speed performance perspective. The inefficiency stems from use of power and time resources to initialize and/or train the sideband or the mainband in which no error has occurred.

Various embodiments address and overcome the foregoing problems by enabling training of a part (referred to as a “first part” herein) of a UCIe link, including sideband or mainband of a lane of the UCIe link, in which an error has occurred, and maintaining active another part (referred to as a “second part” herein) of the UCIe link, including the other of the sideband or mainband, during the training. As such, the embodiments avoid using power and time resources to unnecessarily train a part of the UCIe link in which no error has occurred. The embodiments also avoid performance degradation that would occur if the part or parts of the UCIe link in which no error has occurred were made unavailable through unnecessary training.

Operations for performance and power efficient UCIe link error recovery may begin with identifying one or more parts (first part or parts) of a UCIe link, including sideband and/or mainband of a lane of the UCIe link, in which an error has occurred. The identification in which one or more parts of the UCIe link an error has occurred may be implemented via different mechanisms for the sideband and for the mainband. An expiration of a period, or timeout, for a sideband message may be interpreted as an error occurring in the sideband. An error state (“TRAINERROR”) handshake request for entering the error state may be interpreted as an error occurring in the mainband. An expiration of a period, or timeout, for a response to the error state handshake request may be interpreted as an error occurring in the sideband in addition to the error occurring in the mainband. Identification of the one or more parts of the UCIe link in which an error has occurred may trigger recording a value in a UCIe link error recovery structure in which the value is configured to indicate the one or more parts of the UCIe link in which an error has occurred.

Training of the UCIe link may follow the identification of the one or more parts of the UCIe link in which an error has occurred. Rather than training the UCIe link by initializing the sideband and initializing and training the mainband, some embodiments may include maintaining power to a part (“second part”) of the UCIe link in which no error has occurred and initializing and/or training the part (“first part”) or parts of the UCIe line in which an error has occurred. For example, the value of the UCIe link error recovery structure may indicate which part of the UCIe link to initialize and/or train. The part of the UCIe link not indicated by the value of the UCIe link error recovery structure (the “second part”) may remain active by having power maintained during the UCIe link training, and may not be initialized and/or trained. Some embodiments may include initializing the sideband, and initializing and training the mainband for a value of the UCIe link error recovery structure indicating that an error has occurred in the sideband and the mainband.

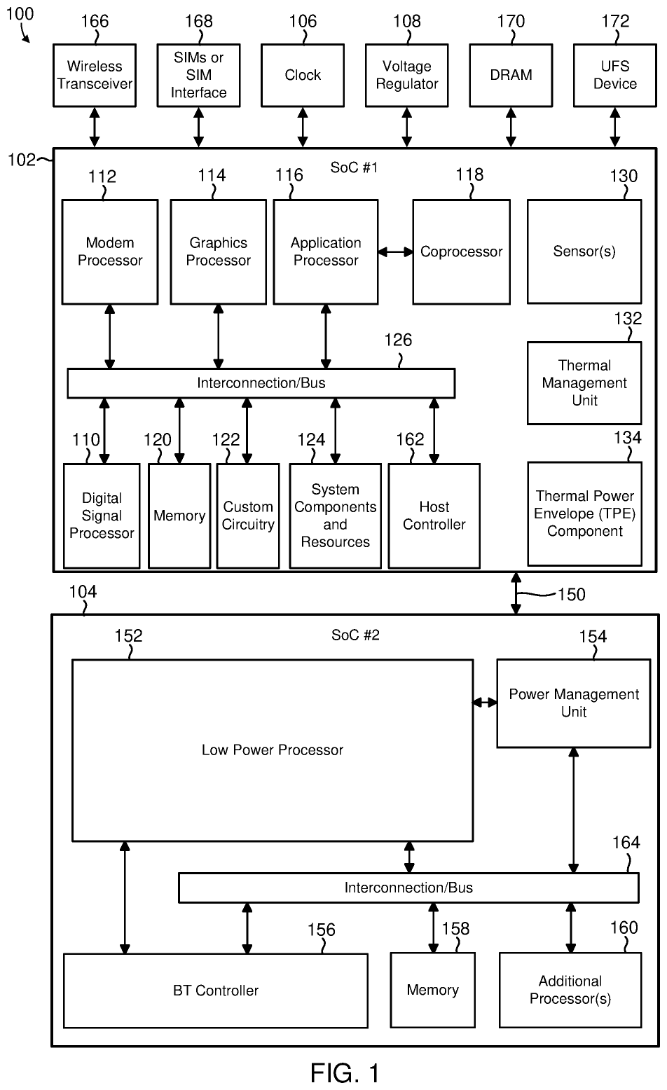

FIG. 1 is a component block diagram illustrating an example computing device 100 suitable for implementing any of the various embodiments. Various embodiments may be implemented in a processing system including a number of single processor and multiprocessor computer systems.

With reference to FIG. 1, the illustrated example computing device 100 (which may be a system-in-a-package in some embodiments) may include any combination of one or more processing systems 102, 104 coupled to a clock 106, a voltage regulator 108, at least one subscriber identity module (SIM) 168 and/or a SIM interface, a DRAM 170, a Universal FLASH Storage (UFS) device 170, a wireless transceiver 166 configured to send and receive wireless communications via an antenna (not shown) to/from wireless computing devices, such as a base station, wireless device, and/or computing device. In some embodiments, the first processing system 102 may operate as central processing unit (CPU) of the computing device 100 that carries out the instructions of software application programs by performing the arithmetic, logical, control and input/output (I/O) operations specified by the instructions. In some embodiments, the second processing system 104 may operate as a specialized processing unit. For example, the second processing system 104 may operate as a specialized 5G processing unit responsible for managing high volume, high speed (e.g., 5 Gbps, etc.), and/or very high frequency short wavelength (e.g., 28 GHz mmWave spectrum, etc.) communications.

The term “system-on-chip” (SoC) is used herein to refer to a set of interconnected electronic circuits typically, but not exclusively, including a processing device, a memory, and a communication interface. One or more processing systems 102, 104 may include a variety of different types of processors some of which may include multiple processor cores. Non-limiting examples of processors that may be included in a computing device 100 and implemented in or coupled to one or more processing systems 102, 104 include a general purpose processor, a central processing unit (CPU), a digital signal processor (DSP), a graphics processing unit (GPU), an accelerated processing unit (APU), a secure processing unit (SPU), a neural network processing unit (NPU), a subsystem processor of specific components of the computing device, such as an image processor for a camera subsystem or a display processor for a display, an auxiliary processor, a single-core processor, a multicore processor, a controller, and a microcontroller. One or more processing systems 102, 104 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material in what may be referred to as a system-on-chip (SoC).

One or more processing systems 102, 104 may be implemented in one or more SoCs and/or may include circuitry in multiple chips coupled to one or more SoCs. The computing device 100 may include more than one processing system 102, 104, thereby increasing the number of processors, any one or more of which may include multiple processor cores. The computing device 100 may also include other processors (not shown) that are not associated with the one or more processing systems 12. The processors may each be configured for specific purposes that may be the same as or different from other processors of the computing device 100. One or more of the processors and processor cores of the same or different configurations may be grouped together.

The first processing system 102 may include one or more of any of a digital signal processor (DSP) 110, a modem processor 112, a graphics processor 114, an application processor (AP) 116, one or more coprocessors 118 (e.g., vector co-processor) connected to one or more of the processors, memory 120, custom circuity 122, system components and resources 124, a host controller 162, an interconnection/bus module 126, one or more sensors 130 (e.g., accelerometer, temperature sensor, pressure sensor, optical sensor, infrared sensor, analog sound sensor, etc.), a thermal management unit 132, and a thermal power envelope (TPE) component 134. The second processing system 104 may include a low power processor 152, a power management unit 154, an interconnection/bus module 164, a BT controller 156, memory 158, and various additional processors 160, such as an applications processor, packet processor, etc.

Each processor 110, 112, 114, 116, 118, 152, 160 may include one or more cores, and each processor/core may perform operations independent of the other processors/cores. For example, the first processing system 102 may include a processor that executes a first type of operating system (e.g., UNIX based OS, LINUX, IOS, MACOS, ANDROID etc.) and a processor that executes a second type of operating system (e.g., MICROSOFT WINDOWS). In addition, any or all of the processors 110, 112, 114, 116, 118, 152, 160 may be included as part of a processor cluster architecture (e.g., a synchronous processor cluster architecture, an asynchronous or heterogeneous processor cluster architecture, etc.).

The first and second processing system 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser or audio/video application. For example, the system components and resources 124 of the first processing system 102 may include power amplifiers, voltage regulators, oscillators, phase-locked loops, peripheral bridges, data controllers, memory controllers, system controllers, access ports, timers, and other similar components used to support the processors and software clients running on a computing device. The system components and resources 124 and/or custom circuitry 122 may also include circuitry to interface with peripheral devices, such as cameras, electronic displays, wireless communication devices, external memory chips, etc.

The first and second processing system 102, 104 may communicate via interconnection/bus module 150. In some embodiments, the interconnection/bus module may be a connection established by transceiving (i.e., receiving and transmitting) components within both the processing system 102 and processing system 104. For example, the low power processor 152 may include a universal asynchronous receiver-transmitter (UART) and the application processor 116 may include a multiple signal messages (MSM) UART driver that is communicatively connected to the UART of the low power processor 152.

The various processors 110, 112, 114, 116, 118, may be interconnected to one or more memory elements 120, system components and resources 124, and custom circuitry 122, and a thermal management unit 132 via an interconnection/bus module 126. Similarly, the low power processor 152 may be interconnected to the power management unit 154, the BT controller 156, memory 158, and various additional processors 160 via the interconnection/bus module 164. The interconnection/bus module 126, 150, 164 may include an array of reconfigurable logic gates and/or implement a bus architecture (e.g., CoreConnect, AMBA, etc.). The interconnection/bus module 126, 150, 164 may include any number of interconnecting buses and bridges depending on the specific application of the processing systems 102, 104 and the overall design constraints. Communications may be provided by advanced interconnects, such as high-performance networks-on chip (NoCs).

The first and/or second processing systems 102, 104 may further include an input/output module (not illustrated) for communicating with resources external to the processing system, such as a clock 106, a voltage regulator 108, one or more wireless transceivers 166, and at least one SIM 168 and/or SIM interface (i.e., an interface for receiving one or more SIM cards). Resources external to the processing system (e.g., clock 106, voltage regulator 108) may be shared by two or more of the internal processing system processors/cores. The at least one SIM 168 (or one or more SIM cards coupled to one or more SIM interfaces) may store information supporting multiple subscriptions, including a first 5GNR subscription and a second 5GNR subscription, etc.

In addition to the example computing device 100 discussed above, various embodiments may be implemented in a wide variety of computing systems, which may include a single processor, multiple processors, multicore processors, or any combination thereof.

In some embodiments, the various processors of the processing system 102 and processing system 104 may be located within a same processing system. For example, the application processor 116 and low power processor 152 may be located within a same processing system, such as in a single processing system of a wearable device.

In some embodiments, any of the components integral to the processing systems 102, 104 may be composed of one or more chiplets configured to communicate with other chiplets according to UCIe protocols.

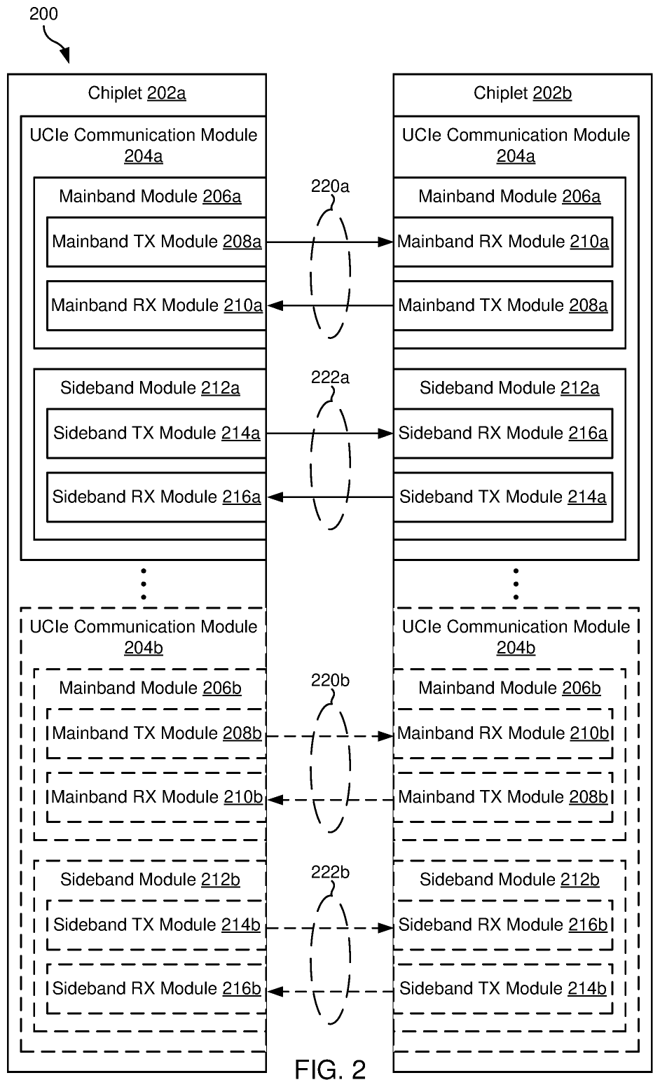

FIG. 2 illustrates an example chiplet configurations of a UCIe system 200 of the computing device (e.g., computing device 100 in FIG. 1) suitable for implementing various embodiments. With reference to FIGS. 1 and 2, the UCIe system 200 may include two or more chiplets 202a, 202b. The chiplets 202a, 202b may be integral to a processing system (e.g., processing system 102, 104 in FIG. 1). In some embodiments, each chiplet 202a, 202b may include one or more UCIe communication modules 204a, 204b. Chiplets 202a, 202b including two or more UCIe communication modules 204a, 204b may be configured as multi-module chiplets.

Each UCIe communication module 204a, 204b may include components for implementing a UCIe link for communication with at least one other chiplet 202a, 202b according to UCIe protocols. For example, each UCIe communication module 204a, 204b may include components for implementing a mainband 220a, 220b of the UCIe link, such as a mainband module 206a, 206b having a mainband transmission (TX) module 208a, 208b and a mainband reception (RX) module 210a, 210b. The mainband transmission (TX) module 208a, 208b of one chiplet 202a, 202b may send transmissions via the mainband 220a, 220b that may be received by the mainband reception (RX) module 210a, 210b of another chiplet 202a, 202b. As another example, each UCIe communication module 204a, 204b may include components for implementing a sideband 222a, 222b of the UCIe link, such as a sideband module 212a, 212b having a sideband transmission (TX) module 214a, 214b and a mainband reception (RX) module 216a, 216b. The sideband transmission (TX) module 214a, 214b of one chiplet 202a, 202b may send transmissions via the sideband 222a, 222b that may be received by the sideband reception (RX) module 216a, 216b of another chiplet 202a, 202b.

Typically, an error occurring for a mainband 220a, 220b, such as at a mainband module 206a, 206b, or a sideband 222a, 222b, such as at a sideband module 212a, 212b, may trigger training of the UCIe link, including training and/or initialization of both the mainband 220a, 220b and the sideband 222a, 222b. For example, an error occurring in the mainband 220a, 220b or the sideband 222a, 222b may trigger a power reset of both the mainband module 206a, 206b and the sideband module 212a, 212b. The UCIe communication module 204a, 204b may again initialize the sideband 222a, 222b and may again initialize and train the mainband 220a, 220b. Training and/or initialization of both the mainband 220a, 220b and the sideband 222a, 222b when an error occurs in only one of the training and/or initialization of both the mainband 220a, 220b or the sideband 222a, 222b is inefficient from a power consumption and speed performance perspective. The inefficiency stems from the use of power and time resources to initialize and/or train the mainband 220a, 220b or the sideband 222a, 222b in which no error has occurred.

Various embodiments enable training of a part (“first part”) of a UCIe link, including the mainband 220a, 220b or the sideband 222a, 222b of a lane of the UCIe link, in which an error has occurred, and maintaining active another part (“second part”) of the UCIe link, including the other of the mainband 220a, 220b or the sideband 222a, 222b, during the training. As such, various embodiments avoid using power and time resources to unnecessarily train parts of the UCIe link in which no error has occurred. The embodiments also avoid performance degradation associated with making the parts of the UCIe link in which no error has occurred unavailable during UCIe link training that is unnecessary for such error-free parts.

In the following example, descriptions involving the UCIe communication module 204a, 204b may include any combination of the mainband module 206a, 206b and/or the sideband module 212a, 212b unless otherwise noted. Performance and power efficient UCIe link error recovery may include identifying one or more parts of a UCIe link, including the mainband 220a, 220b or the sideband 222a, 222b of a lane of the UCIe link, in which an error has occurred (“first part”). The identification in which one or more parts of the UCIe link an error has occurred may be implemented via different mechanisms for the mainband 220a, 220b or the sideband 222a, 222b. For example, expiration of a period, or timeout, for a sideband message may be interpreted by the UCIe communication module 204a, 204b as an error occurring in the sideband 222a, 222b. An error state (“TRAINERROR” of the UCIe LTSSM) handshake request for entering the error state may be interpreted by the UCIe communication module 204a, 204b as an error occurring in the mainband 220a, 220b. An expiration of a period, or timeout, for a response to the error state handshake request may be interpreted by the UCIe communication module 204a, 204b as an error occurring in the sideband 222a, 222b in addition to the error occurring in the mainband 220a, 220b. The UCIe communication module 204a, 204b may identify of the one or more parts of the UCIe link in which an error has occurred and may record a value configured to indicate to the UCIe communication module 204a, 204b the one or more parts of the UCIe link in which an error has occurred. This value may be recorded in a UCIe link error recovery structure, such as in a memory (e.g., memory 120, 158 in FIG. 1) that may include a register.

Training of the UCIe link by the UCIe communication module 204a, 204b may follow the identification of the one or more first parts of the UCIe link in which an error has occurred. Rather than necessarily training the UCIe link by initializing the sideband 222a, 222b and initializing and training the mainband 220a, 220b, some embodiments may include maintaining power to a second part of the UCIe link in which no error has occurred while initializing and/or training the first part(s) of the UCIe line in which an error has occurred. For example, the value of the UCIe link error recovery structure may indicate to the UCIe communication module 204a, 204b which part of the UCIe link to initialize and/or train. The part of the UCIe link not indicated by the value of the UCIe link error recovery structure may remain active, by having power maintained by the UCIe communication module 204a, 204b during the UCIe link training, and may not be initialized and/or trained. Some embodiments may include initializing the sideband 222a, 222b and initializing and training the mainband 220a, 220b for a value of the UCIe link error recovery structure indicating to the UCIe communication module 204a, 204b that an error has occurred in the sideband and the mainband.

The example illustrated in FIG. 2 shows two chiplets 202a, 202b each having one or two UCIe communication modules 204a, 204b, one or two mainbands 220a, 220b, and one or two sidebands 222a, 222b for clarity and ease of explanation. The example illustrated in FIG. 2 is provided for illustrative purposes and is not intended to limit the scope of the specification and claims to this number of chiplets, to this number of UCIe communication modules per chiplet, to this number of mainbands per chiplet, and to this number of sidebands per chiplet. The descriptions of the UCIe system 200 with two chiplets 202a, 202b each having one or two UCIe communication modules 204a, 204b, one or two mainbands 220a, 220b, and one or two sidebands 222a, 222b are similarly applicable to UCIe system with more than two chiplets, to chiplets having more than two UCIe communication modules, to chiplets having more than two mainbands, and/or to chiplets having more than two sidebands.

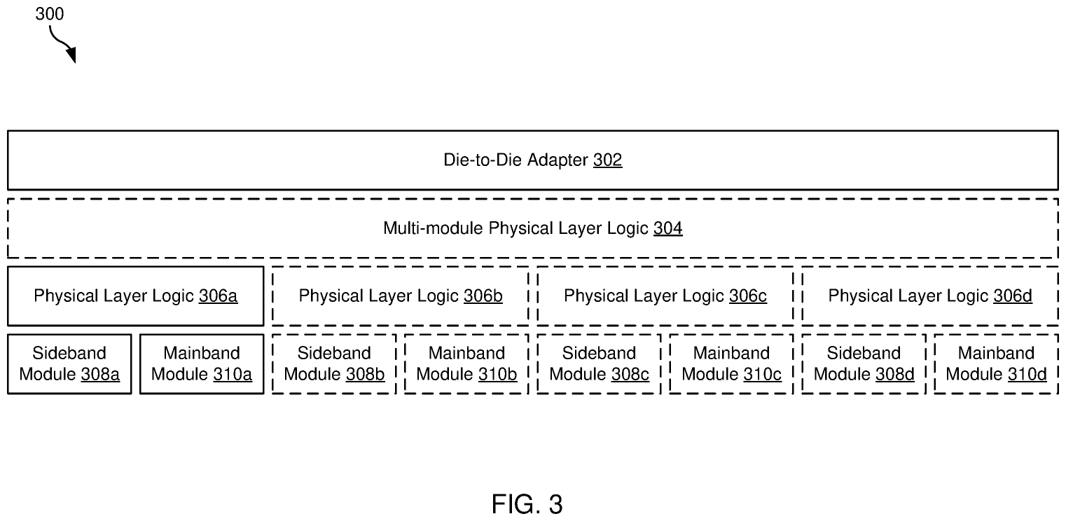

FIG. 3 illustrates an example of a chiplet 300 (e.g., chiplet 202a, 202b in FIG. 2) configured for UCIe for implementing various embodiments. With reference to FIGS. 1-3, the chiplet 300 may be one of multiple chiplets 300 integral to a processing system (e.g., processing system 102, 104 in FIG. 1). The chiplet 300 may include a die-to-die adapter 302, at least one physical layer logic 306a, 306b, 306c, 306d (e.g., UCIe communications module 204a, 204b in FIG. 2), and a sideband module 308a, 308b, 308c, 308d (e.g., sideband module 212a, 212b in FIG. 2) and a mainband module 310a, 310b, 310c, 310d (e.g., mainband module 206a, 206b in FIG. 2) per physical layer logic 306a, 306b, 306c, 306d. In some embodiments, the chiplet 300 may be configured as a multi-module chiplet and may also include a multi-module physical layer logic 304, and at least two physical layer logics 306a, 306b, 306c, 306d and the associated sideband modules 308a, 308b, 308c, 308d and mainband modules 310a, 310b, 310c, 310d.

The die-to-die adapter 302 may be configured to implement link state management and parameter negotiation between chiplets 300. The die-to-die adapter 302 may also be configured to implement optional support for additional data reliability safeguards via cyclic redundancy checks and link-level retries.

In embodiments in which the chiplet 300 may be configured as a single module chiplet, each physical layer logic 306a, 306b, 306c, 306d may be configured to manage and implement the connections via interconnects between chiplets 300 of the same package. For example, each physical layer logic 306a, 306b, 306c, 306d may implement transmitting and receiving voltage signals representing commands and/or data between the die-to-die adapter 302 and the interconnects with other chiplets 300. An active physical layer logic 306a, 306b, 306c, 306d may transmit and/or receive voltage signals via an associated active sideband module 308a, 308b, 308c, 308d and/or an associated active mainband module 310a, 310b, 310c, 310d. In some embodiments, each physical layer logic 306a, 306b, 306c, 306d may implement UCIe link training for performance and power efficient UCIe link error recovery.

In embodiments in which the chiplet 300 may be configured as a multi-module chiplet, the multi-module physical layer logic 304 may be configured to manage and implement the connections via interconnects between multi-module chiplets of the same package. For example, the multi-module physical layer logic 304 may implement transmitting and receiving voltage signals representing commands and/or data between higher layers (not shown) of the chiplet 300 and at least one of the at least two physical layer logics 306a, 306b, 306c, 306d of the chiplet 300. As another example, the multi-module physical layer logic 304 may manage to which and from which of the at least two physical layer logics 306a, 306b, 306c, 306d to transmit and/or receive voltage signals. For example, the multi-module physical layer logic 304 may transmit and/or receive voltage signals from at least one of the at least two physical layer logics 306a, 306b, 306c, 306d that is active, associated with an active sideband module 308a, 308b, 308c, 308d and/or an active mainband module 310a, 310b, 310c, 310d. In some embodiments, the multi-module physical layer logic 304 may implement UCIe link training for performance and power efficient UCIe link error recovery.

Each physical layer logic 306a, 306b, 306c, 306d may be configured to manage and implement the connections via interconnects between chiplets 300 of the same package. For example, each physical layer logic 306a, 306b, 306c, 306d may implement transmitting and receiving voltage signals representing commands and/or data between the multi-module physical layer logic 304 and the interconnects with other multi-module chiplets. An active physical layer logic 306a, 306b, 306c, 306d may transmit and/or receive voltage signals via an associated active sideband module 308a, 308b, 308c, 308d and/or an associated active mainband module 310a, 310b, 310c, 310d. In some embodiments, each physical layer logic 306a, 306b, 306c, 306d may implement UCIe link training for performance and power efficient UCIe link error recovery.

In the following example, a “component of the chiplet 300” may interchangeably and/or jointly refer to the multi-module physical layer logic 304 and each physical layer logic 306a, 306b, 306c, 306d unless otherwise noted. The example when discussed in terms of each physical layer logic 306a, 306b, 306c, 306d may be applied individually to an associated mainband and/or an associated sideband of each physical layer logic 306a, 306b, 306c, 306d.

A component of the chiplet 300 implementing performance and power efficient UCIe link error recovery, may identify in which part of the UCIe link, including a mainband and/or a sideband, an error has occurred. For example, the component of the chiplet 300 may identify expiration of a period, or timeout, for a sideband message of the sideband, and may interpret the expiration of the period as an error occurring in the sideband. The component of the chiplet 300 may identify an error state (“TRAINERROR” of the UCIe LTSSM) handshake request for entering the error state and may interpret the error state handshake request as an error occurring in the mainband. The component of the chiplet 300 may identify an expiration of a period, or timeout, for a response to the error state handshake request and may interpret the expiration of the period as an error occurring in the sideband in addition to the error occurring in the mainband. Based on identification of the one or more parts of the UCIe link in which an error has occurred, the component of the chiplet 300 may record a value configured to indicate to component of the chiplet 300 the one or more parts of the UCIe link in which an error has occurred in a UCIe link error recovery structure, such as in a memory (e.g., memory 120, 158 in FIG. 1) that may include a register.

The component of the chiplet 300 may train the UCIe link following the identification of the one or more parts of the UCIe link in which an error has occurred. Rather than necessarily training the UCIe link by initializing the sideband, and initializing and training the mainband, some embodiments may include the component of the chiplet 300 maintaining power to a part of the UCIe link in which no error has occurred and initializing and/or training a part of the UCIe line in which an error has occurred. For example, the value of the UCIe link error recovery structure may indicate to the component of the chiplet 300 may which part of the UCIe link to initialize and/or train. The part of the UCIe link not indicated by the value of the UCIe link error recovery structure may remain active, by the component of the chiplet 300 maintaining power to the sideband module 308a, 308b, 308c, 308d and/or the mainband module 310a, 310b, 310c, 310d during the UCIe link training. The part of the UCIe link not indicated by the value of the UCIe link error recovery structure may not be initialized and/or trained by the component of the chiplet 300. Some embodiments may include the component of the chiplet 300 initializing the sideband 222a, 222b and initializing and training the mainband 220a, 220b for a value of the UCIe link error recovery structure indicating to component of the chiplet 300 that an error has occurred in the sideband and the mainband.

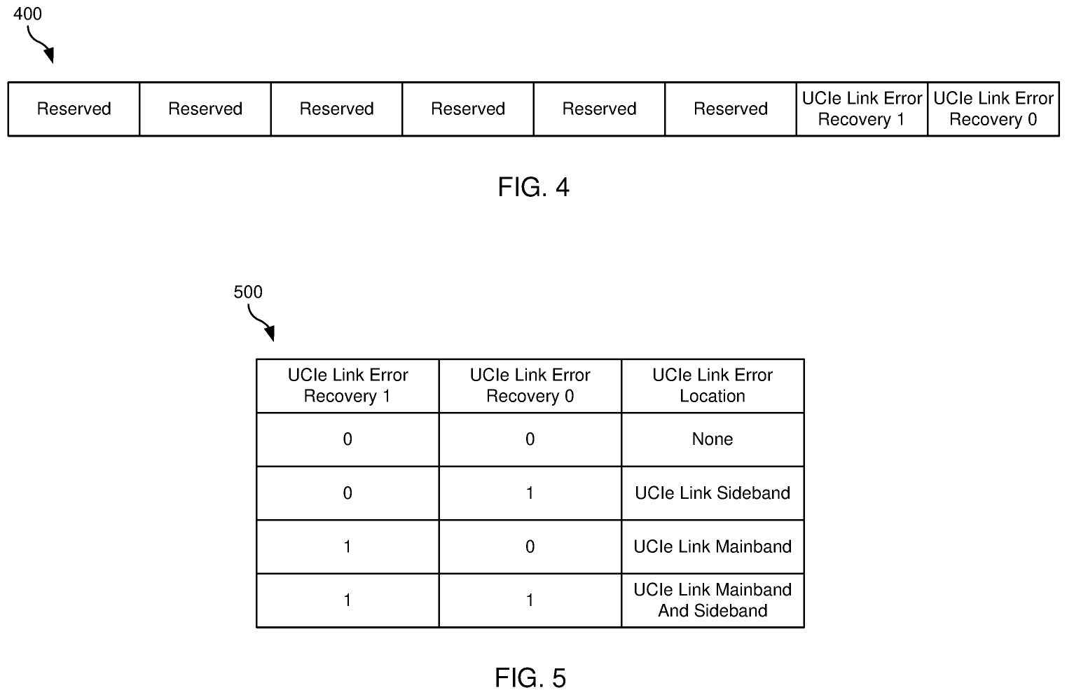

In the following examples described with reference to FIGS. 4-12, a mainband module (e.g., mainband module 206a, 206b in FIG. 2, mainband module 310a, 310b, 310c, 310d in FIG. 3) and an associated mainband (e.g., mainband 220a, 220b in FIG. 2) may be referred to interchangeably. In the following examples described with reference to FIGS. 4-6, a sideband module (e.g., sideband module 212a, 212b in FIG. 2, sideband module 308a, 308b, 308c, 308d in FIG. 3) and an associated sideband (e.g., sideband 222a, 222b in FIG. 2) may be referred to interchangeably. The examples are described in terms of mainbands and sidebands for clarity and ease of explanation.

FIG. 4 illustrates an example of a UCIe link error recovery data structure 400 for storage in memory suitable for implementing various embodiments. With reference to FIGS. 1-4, the UCIe link error recovery data structure 400 may be configured to include in memory storage of data for implementing performance and power efficient UCIe link error recovery. In some embodiments, the UCIe link error recovery data structure 400 may be and/or may be stored in a memory (e.g., memory 120, 158 in FIG. 1), such as a register. The UCIe link error recovery data structure 400 may be stored in memory that is a component of a chiplet (e.g., chiplet 202a, 202b in FIG. 2, chiplet 300 in FIG. 3). The UCIe link error recovery data structure 400 may be stored in a memory accessible by a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

The UCIe link error recovery data structure 400 may include at least two UCIe link error recovery data fields (e.g., UCIe link error recovery 1, UCIe link error recovery 0). The UCIe link error recovery data field may be configured to represent to the chiplet in which one or more parts of a UCIe link an error is identified. For example, in response to identifying an error in the one or more parts of the UCIe link, a value may be set at one or more of the at least two UCIe link error recovery data fields in a manner configured to indicate one or more parts of the UCIe link in which the error is identified. The values stored in the UCIe link error recovery data fields may indicate an error identified for a mainband, for a sideband, and/or for a mainband and a sideband.

An example of how the UCIe link error recovery data may relate to the one or more parts of the UCIe link in which the error is identified is illustrated in FIG. 5. With reference to FIGS. 1-5, a table 500 illustrates an example of how different values of two UCIe link error recovery data (e.g., UCIe link error recovery 1, UCIe link error recovery 0) may represent the one or more parts of the UCIe link the error is identified (e.g., “None,” “UCIe Link Sideband,” “UCIe Link Mainband,” “UCIe Link Mainband and Sideband”). For example: UCIe link error recovery data of values “00” may represent no error identified for any of the parts of the UCIe ling; UCIe link error recovery data of values “01” may represent the UCIe link sideband as the part of the UCIe link in which the error is identified; UCIe link error recovery data of values “10” may represent the UCIe link mainband as the part of the UCIe link in which the error is identified; and UCIe link error recovery data of values “11” may represent the UCIe link mainband and sideband as the parts of the UCIe link in which the error is identified. In some embodiments, the values “00” of UCIe link error recovery data may be a default value at the UCIe link error recovery structure 400 resulting in an indication of no error identified for any part of the UCIe link by default.

In some embodiments, a software and/or firmware executed by the chiplet may write data to the UCIe link error recovery structure 400. For example, the software and/or firmware may write values of the UCIe link error recovery data to the UCIe link error recovery structure 400 based on identification of an error for one or more of the parts of the UCIe link. The software and/or firmware may be configured to implement a process for UCIe link training for performance and power efficient UCIe link error recovery based on the UCIe link error recovery data of the UCIe link error recovery structure 400.

The chiplet may read the values of the UCIe link error recovery data from the UCIe link error recovery structure 400 during UCIe link training triggered by the error and train the UCIe link. During the UCIe link training, the chiplet may initialize and/or train the one or more parts of the UCIe link in which an error has occurred and/or maintain active a part of the UCIe link in which no error has occurred.

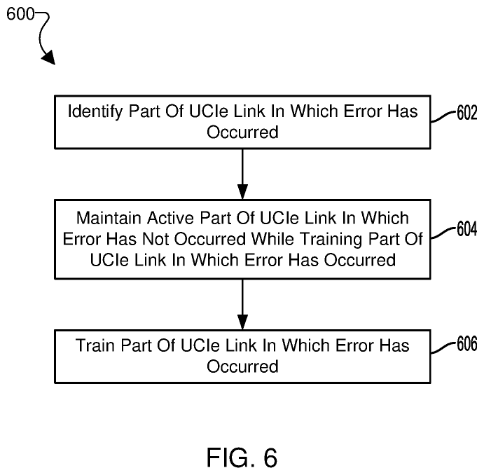

FIG. 6 illustrates an example method 600 for implementing UCIe link error recovery according to various embodiments. With reference to FIGS. 1-6, the method 600 may be implemented in a computing device (e.g., computing device 100, processing system 102, 104 in FIG. 1, UCIe system 200 in FIG. 2), in hardware (e.g., UCIe communications module 204a, 204b in FIG. 2, multi-module physical layer logic 304, physical layer logic 306a, 306b, 306c, 306d in FIG. 3), in software (e.g., UCIe communications module 204a, 204b in FIG. 2, multi-module physical layer logic 304, physical layer logic 306a, 306b, 306c, 306d in FIG. 3) executing in a UCIe link configuration device processing system including a processing system (e.g., chiplet 202a, 202b, 300 in FIGS. 2 and 3), or in a combination of a software-configured processor and dedicated hardware (e.g., chiplet 202a, 202b, 300 in FIGS. 2 and 3), that includes other individual components, such as various memories/caches (e.g., UCIe link error recovery structure 400 in FIG. 4) and various memory/cache controllers. Means for implementing the method 600 may include a processing system or other processors (e.g., chiplet 202a, 202b, 300 in FIGS. 2 and 3, UCIe communications module 204a, 204b in FIG. 2, multi-module physical layer logic 304, physical layer logic 306a, 306b, 306c, 306d in FIG. 3). Further, one or more processors may be configured with software or firmware to perform some or all of the operations of the method 600. In order to encompass the alternative configurations enabled in various embodiments, the hardware implementing the method 600 is referred to herein as a “UCIe link configuration device.”

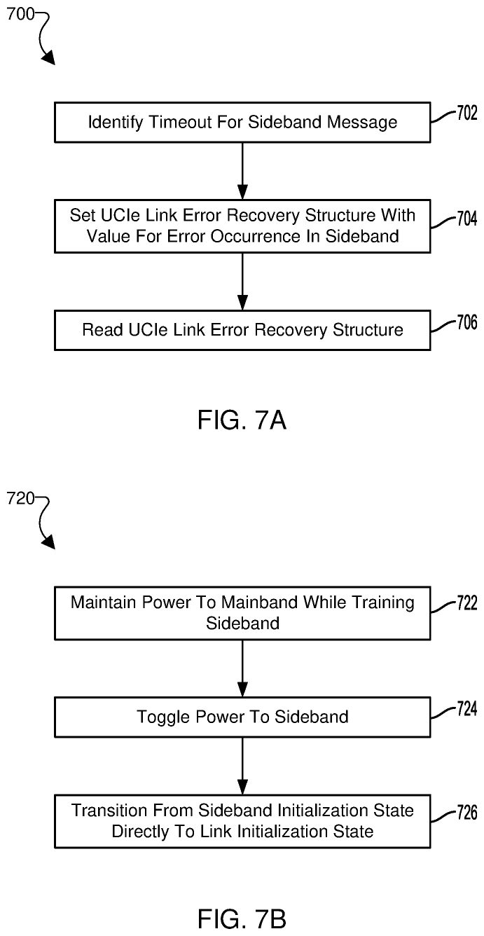

In block 602, the UCIe link configuration device may identify a part (“first part”) of a UCIe link in which an error has occurred. The parts of the UCIe link may include a mainband (e.g., mainband module 206a, 206b, mainband 220a, 220b in FIG. 2, mainband module 310a, 310b, 310c, 310d in FIG. 3) and/or a sideband (e.g., sideband module 212a, 212b, sideband 222a, 222b in FIG. 2, sideband module 308a, 308b, 308c, 308d in FIG. 3). In some embodiments, the UCIe link configuration device identifying the part of the UCIe link in which the error has occurred in block 602 may include a chiplet (e.g., chiplet 202a, 202b, 300 in FIGS. 2 and 3), a UCIe communications module (e.g., UCIe communications module 204a, 204b in FIG. 2), a multi-module physical layer logic (e.g., multi-module physical layer logic 304 in FIG. 3), and/or a Further details on how parts of the UCI link experiencing an error may be identified by the UCIe link configuration device are provided herein with reference to FIGS. 7A-11A.

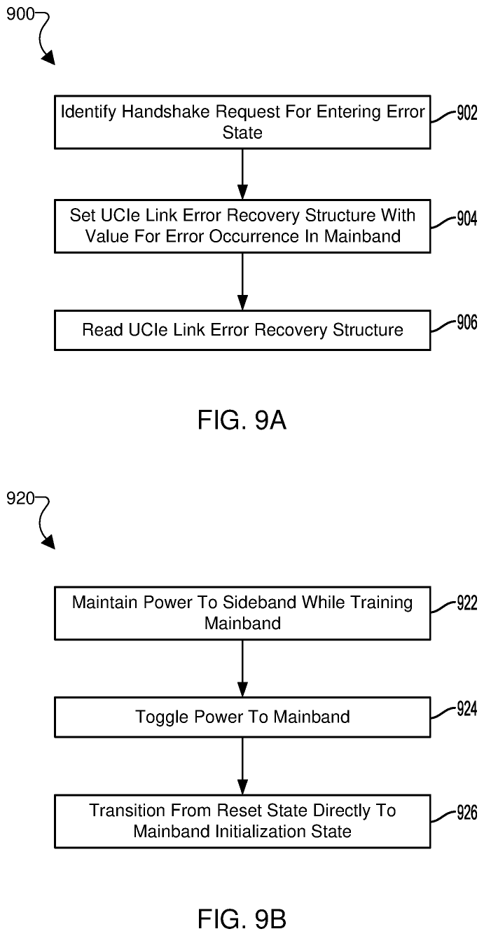

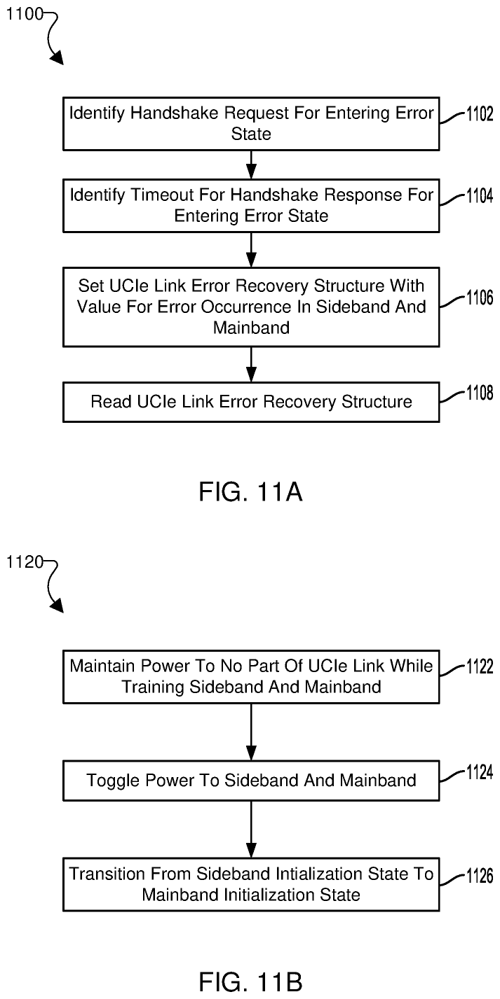

Following are some non-limiting examples of parts of a UCIe link in which an error may occur and be identified by the UCIe link configuration device in block 602. An error may occur in the sideband of the UCIe link, and the UCIe link configuration device may identify that the error has occurred in the sideband as described regarding the method 700 with reference to FIG. 7A. An error may occur in the mainband of the UCIe link, and the UCIe link configuration device may identify that the error has occurred in the mainband as described further herein for the method 900 with reference to FIG. 9A. An error may include one or more errors that occur in the mainband and the sideband of the UCIe link, and the UCIe link configuration device may identify that the error has occurred in the mainband and the sideband as described further herein for the method 1100 with reference to FIG. 11A.

In block 604, the UCIe link configuration device may maintain active a part (“second part”) of the UCIe link in which an error has not occurred. The parts of the UCIe link may include the mainband and/or the sideband. The UCIe link configuration device may maintain active the part of the UCIe link in which an error has not occurred while training the part of the UCIe link in which an error has occurred. Maintaining active the part of the UCIe link in which an error has not occurred may include maintaining power to the sideband and/or the mainband in which an error has not occurred during the UCIe link training. In some embodiments, there may be no part of the UCIe link in which an error has not occurred. For such embodiments, the UCIe link configuration device may maintain active no part of the UCIe link while training the part of the UCIe link in which an error has occurred. In some embodiments, the UCIe link configuration device maintaining active the part of the UCIe link in which an error has not occurred in block 604 may include the chiplet, the UCIe communications module, the multi-module physical layer logic, and/or the physical layer logic.

In block 606, the UCIe link configuration device may train the part (“first part”) of UCIe link in which the error has occurred. The error may occur in the sideband of the UCIe link, and the UCIe link configuration device may train the sideband as described further herein for the method 720 with reference to FIG. 7B. The error may occur for the mainband of the UCIe link, and the UCIe link configuration device may train the mainband as described further herein for the method 920 with reference to FIG. 9B. The error may be one or more errors that may occur in the mainband and the sideband of the UCIe link, and the UCIe link configuration device may train the mainband and the sideband as described further herein for the method 1120 with reference to FIG. 11B. In some embodiments, the UCIe link configuration device training the part of the UCIe link in which the error has occurred in block 606 may include the chiplet, the UCIe communications module, the multi-module physical layer logic, and/or the physical layer logic.

FIGS. 7A and 7B illustrate example methods 700, 720 for implementing UCIe link error recovery for a sideband according to various embodiments. With reference to FIGS. 1-7B, the methods 700, 720 may be implemented in a computing device (e.g., computing device 100, processing system 102, 104 in FIG. 1, UCIe system 200 in FIG. 2), in hardware (e.g., UCIe communications module 204a, 204b in FIG. 2, multi-module physical layer logic 304, physical layer logic 306a, 306b, 306c, 306d in FIG. 3), in software (e.g., UCIe communications module 204a, 204b in FIG. 2, multi-module physical layer logic 304, physical layer logic 306a, 306b, 306c, 306d in FIG. 3) executing in a processor (e.g., chiplet 202a, 202b, 300 in FIGS. 2 and 3), or in a combination of a software-configured processor and dedicated hardware (e.g., chiplet 202a, 202b, 300 in FIGS. 2 and 3), that includes other individual components, such as various memories/caches (e.g., UCIe link error recovery structure 400 in FIG. 4) and various memory/cache controllers. Means for implementing the method 600 may include a processing system or other processors (e.g., chiplet 202a, 202b, 300 in FIGS. 2 and 3, UCIe communications module 204a, 204b in FIG. 2, multi-module physical layer logic 304, physical layer logic 306a, 306b, 306c, 306d in FIG. 3). Further, one or more processors may be configured with software or firmware to perform some or all of the operations of the methods 700, 720. In order to encompass the alternative configurations enabled in various embodiments, the hardware implementing the methods 700, 720 is referred to herein as a “UCIe link configuration device.”

With reference to FIG. 7A, in block 702, the UCIe link configuration device may identify an expiration of a period, or timeout, for a sideband message. Messages between chiplets (e.g., chiplet 202a, 202b, 300 in FIGS. 2 and 3) transmitted via a sideband (e.g., sideband module 212a, 212b, sideband 222a, 222b in FIG. 2, sideband module 308a, 308b, 308c, 308d in FIG. 3) may be referred to as sideband messages. A chiplet transmitting a sideband message to another chiplet may expect and/or require a response to the sideband message. The response may be expected and/or required to be received by the chiplet within the period, which may be measured by various scales, such as time and/or events. The UCIe link configuration device may implement a mechanism for identifying the expiration of the period, such as a time and/or a counter. Upon expiration of the period prior to receiving the response to the sideband message, the UCIe link configuration device may identify the expiration of the period, or timeout, for the sideband message. Identifying the expiration of the period, or timeout, for the sideband message may correspond with identifying an error has occurred in the sideband, which may be referred to as a first part of the UCIe link. In some embodiments, the UCIe link configuration device identifying the expiration of the period, or timeout, for the sideband message in block 702 may include a chiplet (e.g., chiplet 202a, 202b, 300 in FIGS. 2 and 3), a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

In block 704, the UCIe link configuration device may set a UCIe link error recovery structure (e.g., UCIe link error recovery structure 400 in FIG. 4) with a value for the error occurrence in the sideband. In response to identifying the expiration of the period, or timeout, for the sideband message in block 702, the UCIe link configuration device may set the value for the error occurrence in the sideband at the UCIe link error recovery structure. The value for the error occurrence for the sideband at the UCIe link error recovery structure may be configured to indicate to the UCIe link configuration device that the error has occurred in the sideband. Similarly, the value for the error occurrence for the sideband at the UCIe link error recovery structure may be configured to indicate to the UCIe link configuration device that an error has not occurred in a mainband (e.g., mainband module 206a, 206b, mainband 220a, 220b in FIG. 2, mainband module 310a, 310b, 310c, 310d in FIG. 3), which may be referred to as a second part of the UCIe. For example, as discussed herein with reference to the examples in FIGS. 4 and 5, the UCIe link error recovery data of value “01,” respectively, may be set at the UCIe link error recovery structure. In some embodiments, the UCIe link configuration device setting the UCIe link error recovery structure with the value for the error occurrence in the sideband in block 704 may include the chiplet, the UCIe communications module, the multi-module physical layer logic, and/or the physical layer logic.

In block 706, the UCIe link configuration device may read the UCIe link error recovery structure. The UCIe link configuration device may read the UCIe link error recovery data from the UCIe link error recovery structure and interpret from the UCIe link error recovery data the part of the UCIe link in which the error has occurred. In this example, the UCIe link error recovery data is configured to indicate that the error has occurred in the sideband, and the UCIe link configuration device may interpret that the error has occurred in the sideband. In some embodiments, the UCIe link configuration device reading the UCIe link error recovery structure in block 706 may include the chiplet, the UCIe communications module, the multi-module physical layer logic, and/or the physical layer logic.

With reference to FIG. 7B, in block 722, the UCIe link configuration device may maintain power to a mainband (e.g., mainband module 206a, 206b, mainband 220a, 220b in FIG. 2, mainband module 310a, 310b, 310c, 310d in FIG. 3) while training a sideband (e.g., sideband module 212a, 212b, sideband 222a, 222b in FIG. 2, sideband module 308a, 308b, 308c, 308d in FIG. 3). Rather than toggle power to the mainband as would typically occur during UCIe link training, the UCIe link configuration device may maintain power to the mainband. Maintaining the power to the mainband may maintain any parameters and/or settings for the mainband implemented based on a prior initialization and/or training of the mainband during a prior training of the UCIe link. The mainband may continue operation during the UCIe link training. In some embodiments, the UCIe link configuration device maintaining the power to the mainband while training the sideband in block 722 may include a chiplet (e.g., chiplet 202a, 202b, 300 in FIGS. 2 and 3), a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

In block 724, the UCIe link configuration device may toggle power to the sideband. Toggling power to the sideband may temporarily deprive the sideband of power long enough for the sideband connection between chiplets to be deactivated. Toggling power to the sideband may cause any parameters and/or settings for the sideband implemented based on a prior initialization of the sideband during a prior training of the UCIe link to be lost. Toggling power to the sideband may trigger a sideband initialization by the UCIe link configuration device to set parameters and/or settings for the sideband. Setting the parameters and/or settings for the sideband may include setting the same and/or different parameters and/or settings for the sideband as the prior initialization of the sideband during the prior training of the UCIe link. Toggling power to the sideband may occur during a reset state (“RESET” of the UCIe LTSSM) and transition to a sideband initialization state (“SBINIT” of the UCIe LTSSM). In some embodiments, the UCIe link configuration device toggling power to the sideband in block 724 may include the chiplet, the UCIe communications module, the multi-module physical layer logic, and/or the physical layer logic.

In block 726, the UCIe link configuration device may transition from the sideband initialization state directly to a link initialization state (“LINKINIT” of the UCIe LTSSM). Transitioning directly from the sideband initialization state to the link initialization state may bypass a mainband initialization state (“MBINIT” of the UCIe LTSSM) and a mainband training state (“MBTRAIN” of the UCIe LTSSM). Transitioning directly from the sideband initialization state to the link initialization state avoids using power and time resources of implementing mainband initialization and training and enables the mainband to continue operating without interruption by the UCIe training. In some embodiments, the UCIe link configuration device transitioning from the sideband initialization state directly to the link initialization state in block 726 may include the chiplet, the UCIe communications module, the multi-module physical layer logic, and/or the physical layer logic.

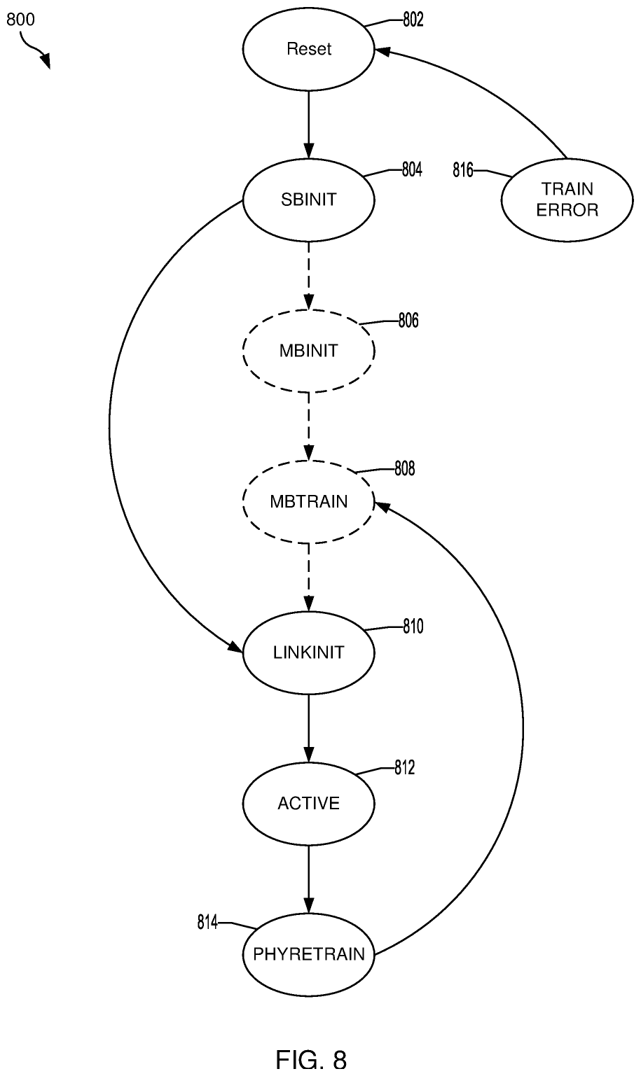

FIG. 8 illustrates an example UCIe link training status and state machine (LTSSM) 800 suitable for implementing various embodiments. With reference to FIGS. 1-8, the UCIe LTSSM 800 may be implemented for UCIe link training by a chiplet (e.g., chiplet 202a, 202b in FIG. 2, chiplet 300 in FIG. 3), including by a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

An error state 816 (“TRAINERROR”) may be a transition state to a UCIe link to a reset state 802 (“RESET”) in response to any fatal and/or non-fatal error event. The error event may include an error event for a sideband (e.g., sideband module 212a, 212b, sideband 222a, 222b in FIG. 2, sideband module 308a, 308b, 308c, 308d in FIG. 3) and/or a mainband (e.g., mainband module 206a, 206b, mainband 220a, 220b in FIG. 2, mainband module 310a, 310b, 310c, 310d in FIG. 3). In the example illustrated in FIG. 8, the error event may be an error event for the sideband. The chiplet may identify an expiration of a period, or timeout, for a sideband message. The period may be on the order of milliseconds (ms), including between 1 ms and 1000 ms, such as 8 ms. Upon expiration of the period, the error state 816 may be entered.

In the reset state 802 the UCIe link may be reset. In some embodiments, rather than resetting the whole UCIe link, the sideband and/or the mainband may be reset. Resetting the sideband and/or the mainband may include toggling power to the sideband and/or the mainband. Whether to reset the sideband and/or the mainband may be indicated by a value of UCIe link recovery data of a UCIe link recovery structure (e.g., UCIe link recovery structure 400 in FIG. 4). The value of UCIe link recovery data may be configured to indicate whether the error occurred in the sideband and/or the mainband. In the example illustrated in FIG. 8, the chiplet, having identified an error has occurred in the sideband based on the value of UCIe link recovery data, may toggle power to the sideband and maintain power to the mainband. Implementing the reset state may trigger a sideband initialization state 804 (“SBINIT”).

In the sideband initialization state 804, the sideband may be initialized with any parameters and/or setting for activating and operating the sideband. Typically, following the side sideband initialization state 804, a mainband initialization state 806 (“MBINIT”) and a mainband training state 808 (“MBTRAIN”) may be implemented. In the example illustrated in FIG. 8, the chiplet may bypass the mainband initialization state 806 and the mainband training state 808 while maintaining power to the mainband enabling the mainband to continue operating without interruption by the UCIe training. Rather, a link initialization state 810 (“LINKINIT”) may be implemented following the sideband initialization state 804.

The link initialization state 810, an active state 812 (“ACTIVE”), and a physical layer retraining state 814 (“PHYRETRAIN”) may each be implemented as known. Other aspects of the LTSSM 800, such as low power states and paths between the power states and other states, are omitted for clarity and ease of explanation, but one of skill in the art would realize that such omitted states may be included and implemented as known.

FIGS. 9A and 9B illustrate example methods 900, 920 for implementing UCIe link error recovery for a mainband according to various embodiments. With reference to FIGS. 1-9B, the methods 900, 920 may be implemented in a computing device (e.g., computing device 100, processing system 102, 104 in FIG. 1, UCIe system 200 in FIG. 2), in hardware (e.g., UCIe communications module 204a, 204b in FIG. 2, multi-module physical layer logic 304, physical layer logic 306a, 306b, 306c, 306d in FIG. 3), in software (e.g., UCIe communications module 204a, 204b in FIG. 2, multi-module physical layer logic 304, physical layer logic 306a, 306b, 306c, 306d in FIG. 3) executing in a processor (e.g., chiplet 202a, 202b, 300 in FIGS. 2 and 3), or in a combination of a software-configured processor and dedicated hardware (e.g., chiplet 202a, 202b, 300 in FIGS. 2 and 3), that includes other individual components, such as various memories/caches (e.g., UCIe link error recovery structure 400 in FIG. 4) and various memory/cache controllers. Means for implementing the method 600 may include a processing system or other processors (e.g., chiplet 202a, 202b, 300 in FIGS. 2 and 3, UCIe communications module 204a, 204b in FIG. 2, multi-module physical layer logic 304, physical layer logic 306a, 306b, 306c, 306d in FIG. 3). Further, one or more processors may be configured with software or firmware to perform some or all of the operations of the methods 900, 920. In order to encompass the alternative configurations enabled in various embodiments, the hardware implementing the methods 900, 920 is referred to herein as a “UCIe link configuration device.”

With reference to FIG. 9A, in block 902, the UCIe link configuration device may identify a handshake request for entering an error state (“TRAINERROR” of the UCIe LTSSM). The handshake request for entering the error state may be implemented between chiplets (e.g., chiplet 202a, 202b, 300 in FIGS. 2 and 3) for the UCIe link to enter the error state from most other states, such as a mainband initialization state (“MBINIT” of the UCIe LTSSM), a mainband training state (“MBTRAIN” of the UCIe LTSSM), an active state (“ACTIVE” of the UCIe LTSSM), etc. The handshake request for entering the error state may be triggered by an error for a mainband (e.g., mainband module 206a, 206b, mainband 220a, 220b in FIG. 2, mainband module 310a, 310b, 310c, 310d in FIG. 3). The UCIe link configuration device may identify generation and/or transmission of the handshake request for entering the error state. Identifying the handshake request for entering the error state may correspond with identifying that an error has occurred in the mainband, which may be referred to as a first part of the UCIe link. In some embodiments, the UCIe link configuration device identifying the handshake request for entering the error state in block 902 may include a chiplet (e.g., chiplet 202a, 202b, 300 in FIGS. 2 and 3), a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

In block 904, the UCIe link configuration device may set a UCIe link error recovery structure (e.g., UCIe link error recovery structure 400 in FIG. 4) with a value for the error occurrence in the mainband. In response to identifying the handshake request for entering the error state in block 902, the UCIe link configuration device may set the value for the error occurrence in the mainband at the UCIe link error recovery structure. The value for the error occurrence in the mainband at the UCIe link error recovery structure may be configured to indicate to the UCIe link configuration device that the error has occurred in the mainband. Similarly, the value for the error occurrence in the mainband at the UCIe link error recovery structure may be configured to indicate to the UCIe link configuration device that an error has not occurred in a sideband (e.g., sideband module 212a, 212b, sideband 222a, 222b in FIG. 2, sideband module 308a, 308b, 308c, 308d in FIG. 3), which may be referred to as a second part of the UCIe link. For example, as discussed herein with reference to the examples in FIGS. 4 and 5, the UCIe link error recovery data of value “10,” respectively, may be set at the UCIe link error recovery structure. In some embodiments, the UCIe link configuration device setting the UCIe link error recovery structure with the value for the error occurrence in the mainband in block 904 may include the chiplet, the UCIe communications module, the multi-module physical layer logic, and/or the physical layer logic.

In block 906, the UCIe link configuration device may read the UCIe link error recovery structure. The UCIe link configuration device may read the UCIe link error recovery data from the UCIe link error recovery structure and interpret from the UCIe link error recovery data the part of the UCIe link in which the error has occurred. In this example, the UCIe link error recovery data is configured to indicate that the error has occurred in the mainband, and the UCIe link configuration device may interpret that the error has occurred in the mainband. In some embodiments, the UCIe link configuration device reading the UCIe link error recovery structure in block 906 may include the chiplet, the UCIe communications module, the multi-module physical layer logic, and/or the physical layer logic.

With reference to FIG. 9B, in block 922, the UCIe link configuration device may maintain power to a sideband (e.g., sideband module 212a, 212b, sideband 222a, 222b in FIG. 2, sideband module 308a, 308b, 308c, 308d in FIG. 3) while training a mainband (e.g., mainband module 206a, 206b, mainband 220a, 220b in FIG. 2, mainband module 310a, 310b, 310c, 310d in FIG. 3). Rather than toggle power to the sideband as would typically occur during UCIe link training, the UCIe link configuration device may maintain power to the sideband. Maintaining the power to the sideband may maintain any parameters and/or settings for the sideband implemented based on a prior initialization of the sideband during a prior training of the UCIe link. The sideband may continue operation during the UCIe link training. In some embodiments, the UCIe link configuration device maintaining the power to the sideband while training the mainband in block 922 may include a chiplet (e.g., chiplet 202a, 202b, 300 in FIGS. 2 and 3), a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

In block 924, the UCIe link configuration device may toggle power to the mainband. Toggling power to the mainband may temporarily deprive the mainband of power long enough for the mainband connection between chiplets to be deactivated. Toggling power to the mainband may cause any parameters and/or settings for the mainband implemented based on a prior initialization and/or training of the mainband during a prior training of the UCIe link to be lost. Toggling power to the mainband may trigger a mainband initialization and/or training by the UCIe link configuration device to set parameters and/or settings for the mainband. Setting the parameters and/or settings for the mainband may include setting the same and/or different parameters and/or settings for the mainband as the prior initialization and/or training of the mainband during the prior training of the UCIe link. Toggling power to the mainband may occur during a reset state (“RESET” of the UCIe LTSSM) and transition to a mainband initialization state (“MBINIT” of the UCIe LTSSM). In some embodiments, the UCIe link configuration device toggling power to the mainband in block 924 may include the chiplet, the UCIe communications module, the multi-module physical layer logic, and/or the physical layer logic.

In block 926, the UCIe link configuration device may transition from the reset state directly to the mainband initialization state. Transitioning directly from the reset state to the mainband initialization state may bypass a sideband initialization state (“SBINIT” of the UCIe LTSSM). Transitioning directly from the reset state to the mainband initialization state avoids using power and time resources of implementing sideband initialization and enables the sideband to continue operating without interruption by the UCIe training. In some embodiments, the UCIe link configuration device transitioning from the reset state directly to the mainband initialization state in block 926 may include the chiplet, the UCIe communications module, the multi-module physical layer logic, and/or the physical layer logic.

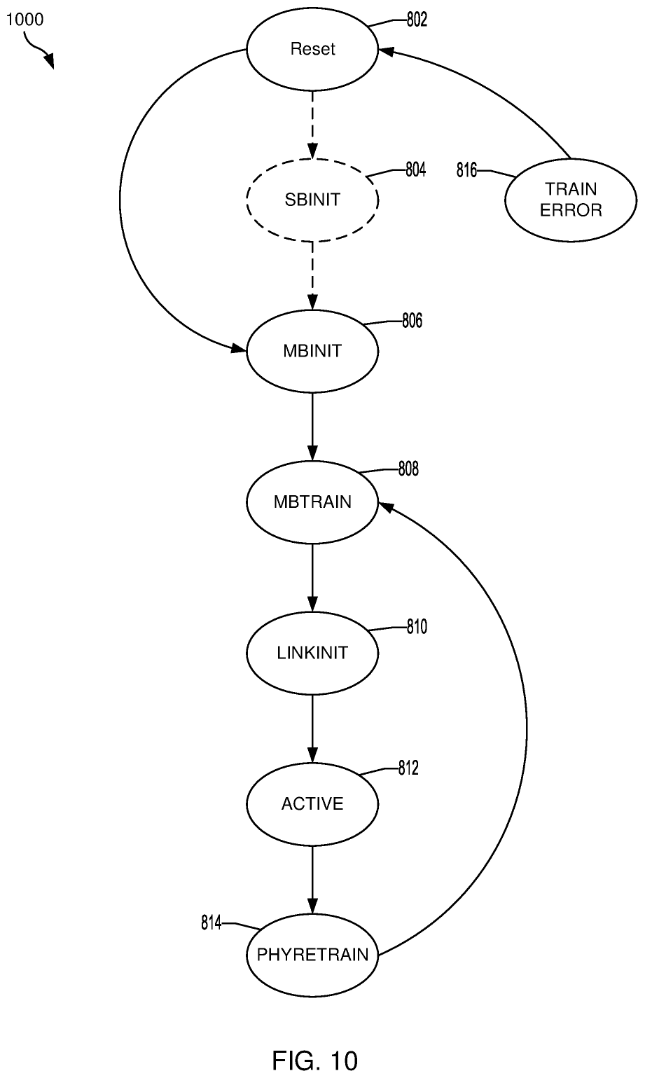

FIG. 10 illustrates an example UCIe link training status and state machine (LTSSM) 1000 suitable for implementing various embodiments. With reference to FIGS. 1-10, the UCIe LTSSM 1000 may be implemented for UCIe link training by a chiplet (e.g., chiplet 202a, 202b in FIG. 2, chiplet 300 in FIG. 3), including by a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

The error state 816 (“TRAINERROR”) may be a transition state to the UCIe link to a reset state 802 (“RESET”) in response to any fatal and/or non-fatal error event. The error event may include an error event for a sideband (e.g., sideband module 212a, 212b, sideband 222a, 222b in FIG. 2, sideband module 308a, 308b, 308c, 308d in FIG. 3) and/or a mainband (e.g., mainband module 206a, 206b, mainband 220a, 220b in FIG. 2, mainband module 310a, 310b, 310c, 310d in FIG. 3). In the example illustrated in FIG. 10, the error event may be an error event for the mainband. The chiplet may identify a handshake request for entering the error state 816. Upon completion of the handshake for entering the error state 816, the error state 816 may be entered.

In the reset state 802 the UCIe link may be reset. In some embodiments, rather than resetting the whole UCIe link, the sideband and/or the mainband may be reset. Resetting the sideband and/or the mainband may include toggling power to the sideband and/or the mainband. Whether to reset the sideband and/or the mainband may be indicated by a value of UCIe link recovery data of a UCIe link recovery structure (e.g., UCIe link recovery structure 400 in FIG. 4). The value of UCIe link recovery data may be configured to indicate whether the error occurred in the sideband and/or the mainband. In the example illustrated in FIG. 10, the chiplet, having identified an error has occurred in the mainband based on the value of UCIe link recovery data, may toggle power to the mainband and maintain power to the sideband.

Implementing the reset state 802 may trigger a mainband initialization state 806 (“MBINIT”). Typically, following the reset state 802 a sideband initialization state 804 (“SBINIT”) may be implemented. In the example illustrated in FIG. 10, the chiplet may bypass the sideband initialization state 804 while maintaining power to the sideband enabling the sideband to continue operating without interruption by the UCIe training. Rather, the mainband initialization state 806 and the mainband initialization state 806 may be implemented following the reset state 802. Following the mainband initialization state 806 a mainband training state 808 (“MBTRAIN”) may be implemented. In the mainband initialization state 806 and the mainband training state 808, the mainband may be initialized and trained with any parameters and/or setting for activating and operating the mainband.

A link initialization state (“LINKINT”) 810, an active state 812 (“ACTIVE”), and a physical layer retraining state 814 (“PHYRETRAIN”) may each be implemented as known. Other aspects of the LTSSM 800, such as low power states and paths between the power states and other states, are omitted for clarity and ease of explanation, but one of skill in the art would realize that such omitted states may be included and implemented as known.

FIGS. 11A and 11B illustrate example methods 1100, 1120 for implementing UCIe link error recovery for a sideband and a mainband according to various embodiments. With reference to FIGS. 1-11B, the methods 1100, 1120 may be implemented in a computing device (e.g., computing device 100, processing system 102, 104 in FIG. 1, UCIe system 200 in FIG. 2), in hardware (e.g., UCIe communications module 204a, 204b in FIG. 2, multi-module physical layer logic 304, physical layer logic 306a, 306b, 306c, 306d in FIG. 3), in software (e.g., UCIe communications module 204a, 204b in FIG. 2, multi-module physical layer logic 304, physical layer logic 306a, 306b, 306c, 306d in FIG. 3) executing in a processor (e.g., chiplet 202a, 202b, 300 in FIGS. 2 and 3), or in a combination of a software-configured processor and dedicated hardware (e.g., chiplet 202a, 202b, 300 in FIGS. 2 and 3), that includes other individual components, such as various memories/caches (e.g., UCIe link error recovery structure 400 in FIG. 4) and various memory/cache controllers. Means for implementing the method 600 may include a processing system or other processors (e.g., chiplet 202a, 202b, 300 in FIGS. 2 and 3, UCIe communications module 204a, 204b in FIG. 2, multi-module physical layer logic 304, physical layer logic 306a, 306b, 306c, 306d in FIG. 3). Further, one or more processors may be configured with software or firmware to perform some or all of the operations of the methods 1100, 1120. In order to encompass the alternative configurations enabled in various embodiments, the hardware implementing the methods 1100, 1120 is referred to herein as a “UCIe link configuration device.”

With reference to FIG. 11A, in block 1102, the UCIe link configuration device may identify a handshake request for entering an error state (“TRAINERROR” of the UCIe LTSSM). The handshake request for entering the error state may be implemented between chiplets (e.g., chiplet 202a, 202b, 300 in FIGS. 2 and 3) for the UCIe link to enter the error state from most other states, such as a mainband initialization state (“MBINIT” of the UCIe LTSSM), a mainband training state (“MBTRAIN” of the UCIe LTSSM), an active state (“ACTIVE” of the UCIe LTSSM), etc. The handshake request for entering the error state may be triggered by an error for a mainband (e.g., mainband module 206a, 206b, mainband 220a, 220b in FIG. 2, mainband module 310a, 310b, 310c, 310d in FIG. 3). The UCIe link configuration device may identify generation and/or transmission of the handshake request for entering the error state. Identifying the handshake request for entering the error state may correspond with identifying that an error has occurred in the mainband, which may be part of what may be referred to as a first part of the UCIe link. In some embodiments, the UCIe link configuration device identifying the handshake request for entering the error state in block 1102 may include a chiplet (e.g., chiplet 202a, 202b, 300 in FIGS. 2 and 3), a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

In block 1104, the UCIe link configuration device may identify an expiration of a period, or timeout, for a handshake response for entering the error state. Messages between chiplets (e.g., chiplet 202a, 202b, 300 in FIGS. 2 and 3) may be transmitted via a sideband (e.g., sideband module 212a, 212b, sideband 222a, 222b in FIG. 2, sideband module 308a, 308b, 308c, 308d in FIG. 3). Such messages transmitted via the sideband may include handshake messages, requests and responses, for entering the error state. A chiplet transmitting a handshake request for entering the error state to another chiplet may expect and/or require a handshake response for entering the error state. The handshake response for entering the error state may be expected and/or required to be received by the chiplet within the period, which may be measured by various scales, such as time and/or events. The UCIe link configuration device may implement a mechanism for identifying the expiration of the period, such as a time and/or a counter. Upon expiration of the period prior to receiving the handshake response for entering the error state, the UCIe link configuration device may identify the expiration of the period, or timeout, for the handshake response for entering the error state. Identifying the expiration of the period, or timeout, for the handshake response for entering the error state may correspond with identifying an error has occurred in the sideband, which may be part of what may be referred to as a first part of the UCIe link. In some embodiments, the UCIe link configuration device identifying the expiration of the period, or timeout, for the handshake response for entering the error state in block 1104 may include the chiplet, the UCIe communications module, the multi-module physical layer logic, and/or the physical layer logic (e.g., physical layer logic 306a, 306b, 306c, 306d in FIG. 3).

In block 1106, the UCIe link configuration device may set a UCIe link error recovery structure (e.g., UCIe link error recovery structure 400 in FIG. 4) with a value for the error occurrence in the mainband and the sideband. In some embodiments, the UCIe link configuration device setting the UCIe link error recovery structure with the value for the error occurrence in the mainband and the sideband in block 1104 may include the chiplet, the UCIe communications module, the multi-module physical layer logic, and/or the physical layer logic.

In response to identifying the handshake request for entering the error state in block 1102 and/or identifying the expiration of the period, or timeout, for the handshake response for entering the error state in block 1104, the UCIe link configuration device may set the value for the error occurrence in the mainband and the sideband at the UCIe link error recovery structure in block 1106. In some embodiments, the UCIe link configuration device setting the value for the error occurrence in the mainband and the sideband at the UCIe link error recovery structure in block 1106 may include the chiplet, the UCIe communications module, the multi-module physical layer logic, and/or the physical layer logic.

In some embodiments, the value for the error occurrence in the mainband and the sideband at the UCIe link error recovery structure may be configured to indicate to the UCIe link configuration device that the error has occurred in the mainband and the sideband. For example, as discussed herein with reference to the examples in FIGS. 4 and 5, the UCIe link error recovery data of value “11,” respectively, may be set at the UCIe link error recovery structure.

In some embodiments, setting the UCIe link error recovery structure with the value for the error occurrence in the mainband and the sideband may be implemented following identifying that errors have occurred in both the mainband and the sideband in blocks 1102 and 1104. For example, the UCIe link configuration device may set the value for the error occurrence in the mainband and the sideband at the UCIe link error recovery structure together (e.g., setting the value as “11”) or sequentially (e.g., setting the value as “10” or “01” and changing the value to “11”).

In some embodiments, setting the UCIe link error recovery structure with the value for the error occurrence in the mainband and the sideband may be implemented as individual operations following each instance of identifying that errors have occurred in both the mainband and the sideband in blocks 1102 and 1104. For example, following identifying that the error has occurred in the mainband in block 1102, the UCIe link configuration device may set the value for the error occurrence in the mainband at the UCIe link error recovery structure (e.g., setting the value as “10”). Then, following identifying that the error has occurred in the sideband in block 1104, the UCIe link configuration device may set the value for the error occurrence in the mainband and the sideband at the UCIe link error recovery structure (e.g., changing the value to “11”).

In block 1108, the UCIe link configuration device may read the UCIe link error recovery structure. The UCIe link configuration device may read the UCIe link error recovery data from the UCIe link error recovery structure and interpret from the UCIe link error recovery data the part of the UCIe link in which the error has occurred, which may be referred to as a second part of the UCIe link. In this example, the UCIe link error recovery data is configured to indicate that the error has occurred in the mainband and the sideband, and the UCIe link configuration device may interpret that the error has occurred in the mainband and the sideband. In some embodiments, the UCIe link configuration device reading the UCIe link error recovery structure in block 1108 may include the chiplet, the UCIe communications module, the multi-module physical layer logic, and/or the physical layer logic.

With reference to FIG. 11B, in block 1122, the UCIe link configuration device may maintain power to no part of a UCIe link while training a sideband (e.g., sideband module 212a, 212b, sideband 222a, 222b in FIG. 2, sideband module 308a, 308b, 308c, 308d in FIG. 3) and a mainband (e.g., mainband module 206a, 206b, mainband 220a, 220b in FIG. 2, mainband module 310a, 310b, 310c, 310d in FIG. 3). Rather than maintaining power to the sideband and/or the mainband as in embodiments described for blocks 722, 922 of the methods 720, 920 with reference to FIGS. 7B and 9B, the UCIe link configuration device may toggle power to each of the sideband and mainband as would typically occur during UCIe link training. For example, and as described herein, the UCIe link configuration device may toggle power to the sideband and the mainband at at least one point during UCIe link training. In some embodiments, the UCIe link configuration device maintaining the power to no part of the UCIe link while training the sideband and the mainband in block 1122 may include a chiplet (e.g., chiplet 202a, 202b, 300 in FIGS. 2 and 3), a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

In block 1124, the UCIe link configuration device may toggle power to the sideband and the mainband. Toggling power to the sideband and the mainband may temporarily deprive the sideband and the mainband of power long enough for the sideband and the mainband connections between chiplets to be deactivated. Toggling power to the sideband and the mainband may cause any parameters and/or settings for the sideband and the mainband implemented based on a prior initialization and/or training of the sideband and the mainband during a prior training of the UCIe link to be lost. Toggling power to the sideband and the mainband may trigger a sideband and mainband initialization and/or training by the UCIe link configuration device to set parameters and/or settings for the sideband and the mainband. Setting the parameters and/or settings for the sideband and the mainband may include setting the same and/or different parameters and/or settings for the sideband and the mainband as the prior initialization and/or training of the sideband and the mainband during the prior training of the UCIe link. Toggling power to the sideband and the mainband may occur during a reset state (“RESET” of the UCIe LTSSM) and transition to a sideband initialization state (“SBINIT” of the UCIe LTSSM). In some embodiments, the UCIe link configuration device toggling power to the sideband and the mainband in block 1124 may include the chiplet, the UCIe communications module, the multi-module physical layer logic, and/or the physical layer logic.

In block 1126, the UCIe link configuration device may transition from the sideband initialization state (“SBINIT” of the UCIe LTSSM) to a mainband initialization state (“MBINIT” of the UCIe LTSSM). Transitioning from the sideband initialization state to the mainband initialization state may be implemented as known and typically occurring during UCIe link training. In some embodiments, the UCIe link configuration device transitioning from the sideband initialization state to the mainband initialization state in block 1126 may include the chiplet, the UCIe communications module, the multi-module physical layer logic, and/or the physical layer logic.

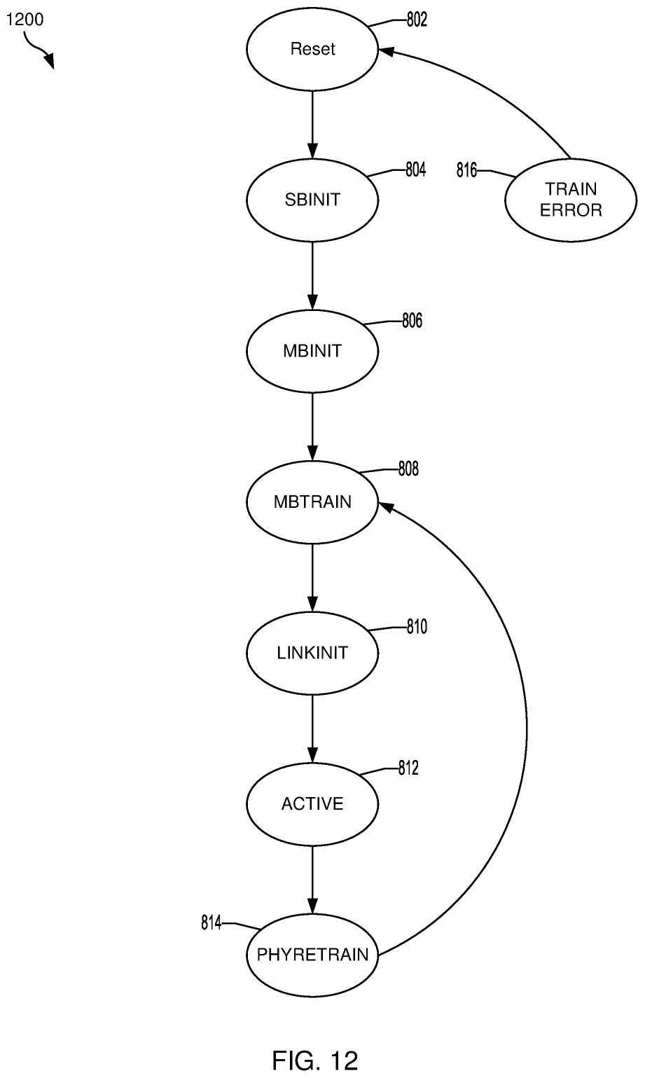

FIG. 12 illustrates an example UCIe link training status and state machine (LTSSM) 1200 suitable for implementing various embodiments. With reference to FIGS. 1-12, the UCIe LTSSM 1200 may be implemented for UCIe link training by a chiplet (e.g., chiplet 202a, 202b in FIG. 2, chiplet 300 in FIG. 3), including by a UCIe communications module (e.g., UCIe communications module 204a, 204b in FIG. 2), a multi-module physical layer logic (e.g., multi-module physical layer logic 304 in FIG. 3), and/or a physical layer logic (e.g., physical layer logic 306a, 306b, 306c, 306d in FIG. 3).

The error state 816 (“TRAINERROR”) may be a transition state to the UCIe link to a reset state 802 (“RESET”) in response to any fatal and/or non-fatal error event. The error event may include an error event for a sideband (e.g., sideband module 212a, 212b, sideband 222a, 222b in FIG. 2, sideband module 308a, 308b, 308c, 308d in FIG. 3) and/or a mainband (e.g., mainband module 206a, 206b, mainband 220a, 220b in FIG. 2, mainband module 310a, 310b, 310c, 310d in FIG. 3). In the example illustrated in FIG. 12, the error event may be an error event for the sideband and the mainband. The chiplet may identify a handshake request for entering the error state 816 and an expiration of a period, or timeout, for a handshake response for entering the error state 816. The period may be on the order of milliseconds (ms), including between 1 ms and 1000 ms, such as 8 ms. Upon expiration of the period, the error state 816 may be entered.

In the reset state 802 the UCIe link may be reset. In some embodiments, the whole UCIe link, the sideband and the mainband may be reset. Resetting the sideband and the mainband may include toggling power to the sideband and the mainband. Whether to reset the sideband and/or the mainband may be indicated by a value of UCIe link recovery data of a UCIe link recovery structure (e.g., UCIe link recovery structure 400 in FIG. 4). The value of UCIe link recovery data may be configured to indicate whether the error occurred in the sideband and/or the mainband. In the example illustrated in FIG. 12, the chiplet, having identified an error has occurred in the sideband and the mainband based on the value of UCIe link recovery data, may toggle power to the sideband and the mainband.

Implementing the reset state 802 may trigger a sideband initialization state 804 (“SBINIT”). The sideband initialization state 804, a mainband initialization state 806 (“MBINIT”), a mainband training state 808 (“MBTRAIN”), a link initialization state 810 (“LINKINT”), an active state 812 (“ACTIVE”), and a physical layer retraining state 814 (“PHYRETRAIN”) may each be implemented as known. Other aspects of the LTSSM 800, such as low power states and paths between the power states and other states, are omitted for clarity and ease of explanation, but one of skill in the art would realize that such omitted states may be included and implemented as known.

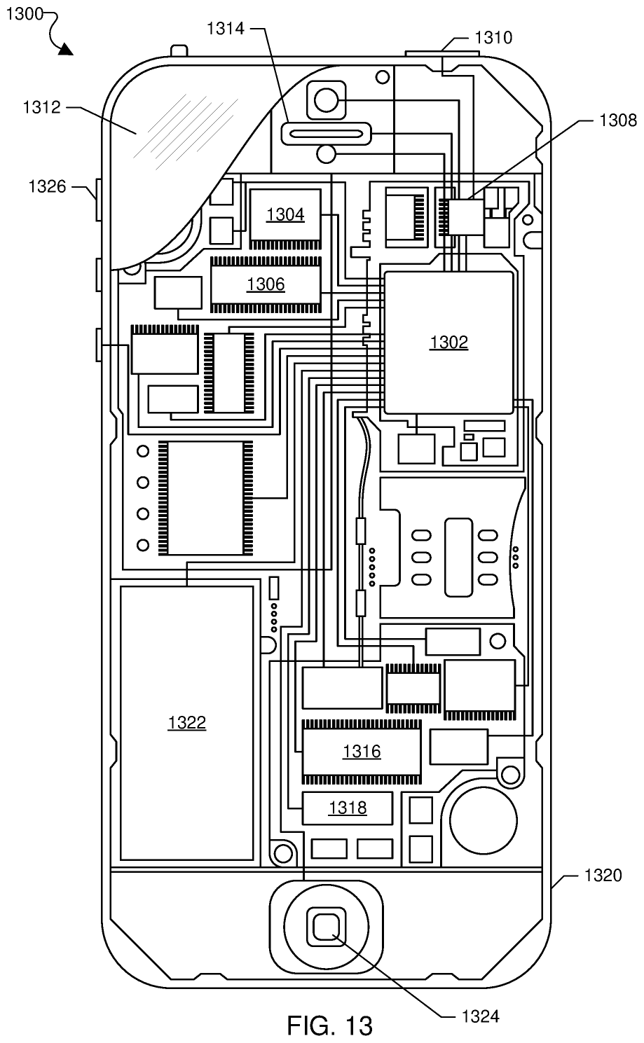

A system in accordance with the various embodiments (including, but not limited to, embodiments described above with reference to FIGS. 1-12) may be implemented in a wide variety of computing systems including mobile computing devices, an example of which suitable for use with the various embodiments is illustrated in FIG. 13. The mobile computing device 1300 may include a processor 1302 coupled to a touchscreen controller 1304 and an internal memory 1306. The processor 1302 may be one or more multicore integrated circuits designated for general or specific processing tasks. The internal memory 1306 may be volatile or non-volatile memory, and may also be secure and/or encrypted memory, or unsecure and/or unencrypted memory, or any combination thereof. Examples of memory types that can be leveraged include but are not limited to DDR, Low-Power DDR (LPDDR), Graphics DDR (GDDR), WIDEIO, RAM, Static RAM (SRAM), Dynamic RAM (DRAM), Parameter RAM (P-RAM), Resistive RAM (R-RAM), Magnetoresistive RAM (M-RAM), Spin-Transfer Torque RAM (STT-RAM), and embedded DRAM. The touchscreen controller 1304 and the processor 1302 may also be coupled to a touchscreen panel 1312, such as a resistive-sensing touchscreen, capacitive-sensing touchscreen, infrared sensing touchscreen, etc. Additionally, the display of the mobile computing device 1300 need not have touch screen capability.

The mobile computing device 1300 may have one or more radio signal transceivers 1308 (e.g., Peanut, Bluetooth, ZigBee, Wi-Fi, RF radio) and antennae 1310, for sending and receiving communications, coupled to each other and/or to the processor 1302. The transceivers 1308 and antennae 1310 may be used with the above-mentioned circuitry to implement the various wireless transmission protocol stacks and interfaces. The mobile computing device 1300 may include a cellular network wireless modem chip 1316 that enables communication via a cellular network and is coupled to the processor.

The mobile computing device 1300 may include a peripheral device connection interface 1318 coupled to the processor 1302. The peripheral device connection interface 1318 may be singularly configured to accept one type of connection, or may be configured to accept various types of physical and communication connections, common or proprietary, such as Universal Serial Bus (USB), FireWire, Thunderbolt, or PCIe. The peripheral device connection interface 1318 may also be coupled to a similarly configured peripheral device connection port (not shown).

The mobile computing device 1300 may also include speakers 1314 for providing audio outputs. The mobile computing device 1300 may also include a housing 1320, constructed of a plastic, metal, or a combination of materials, for containing all or some of the components described herein. The mobile computing device 1300 may include a power source 1322 coupled to the processor 1302, such as a disposable or rechargeable battery. The rechargeable battery may also be coupled to the peripheral device connection port to receive a charging current from a source external to the mobile computing device 1300. The mobile computing device 1300 may also include a physical button 1324 for receiving user inputs. The mobile computing device 1300 may also include a power button 1326 for turning the mobile computing device 1300 on and off.

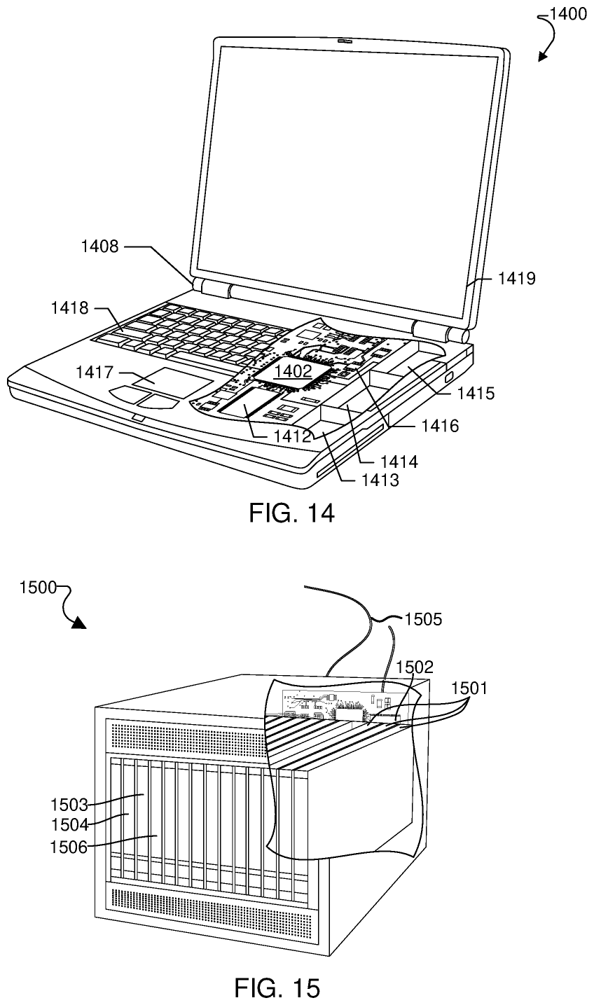

A system in accordance with the various embodiments (including, but not limited to, embodiments described above with reference to FIGS. 1-12) may be implemented in a wide variety of computing systems include a laptop computer 1400, an example of which is illustrated in FIG. 14. Many laptop computers include a touchpad touch surface 1417 that serves as the computer's pointing device, and thus may receive drag, scroll, and flick gestures similar to those implemented on computing devices equipped with a touch screen display and described above. A laptop computer 1400 will typically include a processor 1402 coupled to volatile memory 1412 and a large capacity nonvolatile memory, such as a disk drive 1413 of Flash memory. Additionally, the computer 1400 may have one or more antenna 1408 for sending and receiving electromagnetic radiation that may be connected to a wireless data link and/or cellular telephone transceiver 1416 coupled to the processor 1402. The computer 1400 may also include a floppy disc drive 1414 and a compact disc (CD) drive 1415 coupled to the processor 1402. In a notebook configuration, the computer housing includes the touchpad 1417, the keyboard 1418, and the display 1419 all coupled to the processor 1402. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-12) may also be implemented in fixed computing systems, such as any of a variety of commercially available servers. An example server 1500 is illustrated in FIG. 15. Such a server 1500 typically includes one or more multicore processor assemblies 1501 coupled to volatile memory 1502 and a large capacity nonvolatile memory, such as a disk drive 1504. As illustrated in FIG. 15, multicore processor assemblies 1501 may be added to the server 1500 by inserting them into the racks of the assembly. The server 1500 may also include a floppy disc drive, compact disc (CD) or digital versatile disc (DVD) disc drive 1506 coupled to the processor 1501. The server 1500 may also include network access ports 1503 coupled to the multicore processor assemblies 1501 for establishing network interface connections with a network 1505, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

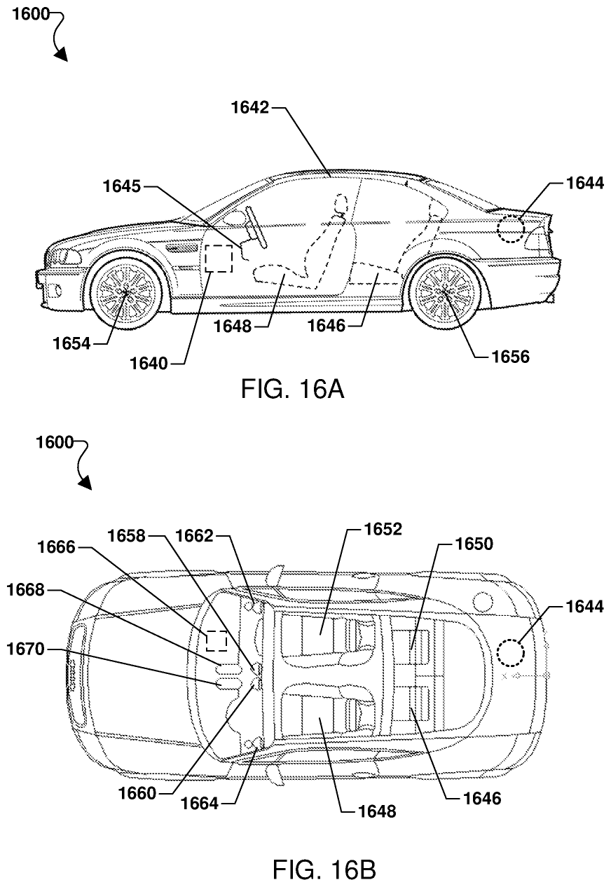

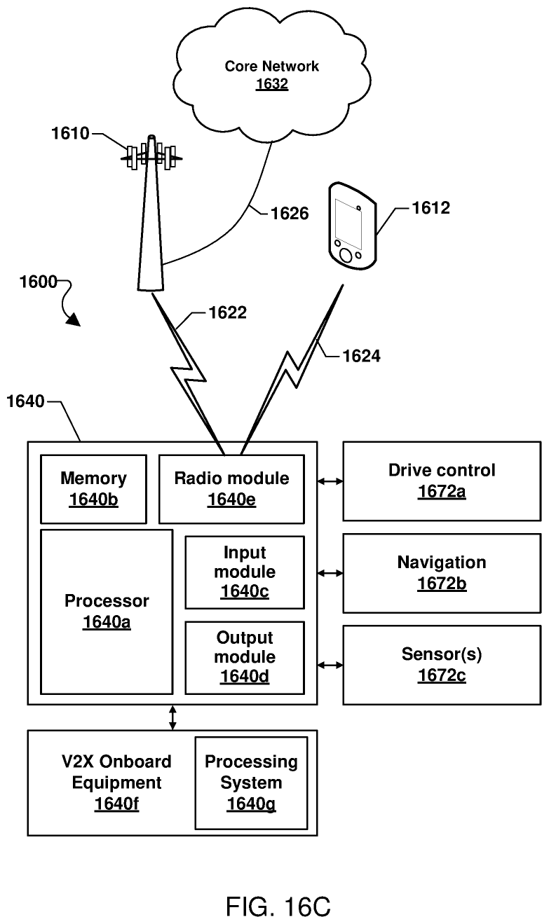

Methods and devices for implementing such methods in accordance with the various embodiments (including, but not limited to, embodiments described above with reference to FIGS. 1-12) may be implemented in a wide variety of computing systems including an embedded vehicle computing system 1600 an example of which is illustrated in FIGS. 16A-16C. An embedded vehicle computing system 1600 may include a vehicle control unit 1640, such as an ECU, which may include a processor, such as a CPU, an artificial intelligence (AI) processor, etc. The embedded vehicle computing system 1600 may include a plurality of sensors 1642-1670, including global navigation satellite system (GNSS) receivers 1642, accelerometers 1644, occupancy sensors 1646, 1648, 1650, 1652, tire pressure sensors 1654, 1656, cameras 1658, 1660, microphones 1662, 1664, impact sensors 1666, external sensors 1668, 1670.

The plurality of sensors 1642-1670, disposed in or on the vehicle, may be used for various purposes, such as navigation, crash avoidance, etc., as well to provide sensor data regarding objects and people in or on the vehicle. The sensors 1642-1670 may include one or more of a wide variety of sensors capable of detecting a variety of information useful for navigation and collision avoidance. Each of the sensors 1642-1670 may be in wired or wireless communication with a control unit 1640, as well as with each other. In particular, the sensors may include one or more cameras 1658, 1660 or other optical sensors or photo optic sensors. The sensors may further include other types of object detection and ranging sensors, such as external sensors 1668, 1670, IR sensors, and ultrasonic sensors. The sensors may further include tire pressure sensors 1654, 1656, humidity sensors, temperature sensors, satellite GNSS receivers 1642, control input sensors 1645, accelerometers 1644, vibration sensors, gyroscopes, gravimeters, impact sensors 1666, force meters, stress meters, strain sensors, fluid sensors, chemical sensors, gas content analyzers, pH sensors, radiation sensors, Geiger counters, neutron detectors, biological material sensors, microphones 1662, 1664, occupancy sensors 1646, 1648, 1650, 1652, proximity sensors, and other sensors.

The vehicle control unit 1640 may include one or more processors configured with processor-executable instructions to perform navigation and collision avoidance operations using information received from various sensors, particularly the cameras 1658, 1660. In some embodiments, the control unit 1640 may supplement the processing of camera images using distance and relative position (e.g., relative bearing angle) that may be obtained from external sensors 1668, 1670. The control unit 1640 may further be configured to control steering, breaking and speed of the vehicle using information regarding other vehicles determined using various embodiments. The vehicle control unit 1640 may include one or more processors configured with processor-executable instructions to receive information from the sensors 1642-1670 and to perform operations using such information as further described herein. In various embodiments, the vehicle control unit 1640 may include, be a component of, or communicate with V2X onboard equipment of the vehicle.

FIG. 16C is a component block diagram illustrating the embedded vehicle computing system 1600 including components and support systems suitable for implementing various embodiments. The embedded vehicle computing system 1600 may include the control unit 1640, which may include various circuits and devices used to control the operation of the vehicle. The control unit 1640 may include a processor 1640a, such as a CPU, an AI processor, etc., a memory 1640b, an input module 1640c, an output module 1640d, and a radio module 1640e. The control unit 1640 may be coupled to and configured to control drive control components 1672a, navigation components 1672b, and one or more sensors 1672c of the embedded vehicle computing system 1600. The control unit 1640 may communicate with V2X onboard equipment 1640f. The processor 1640a may be configured with processor-executable instructions to control maneuvering, navigation, and/or other operations of the vehicle, including operations of various embodiments, including gathering and analyzing real-world vehicle run data gathered from the sensors 1672c. The processor 1640a may be coupled to the memory 1640b. The V2X onboard equipment 1640f may include one or more processors 1640g configured with processor-executable instructions to perform various operations of various embodiments, including communicating real-world vehicle run data gathered from the sensors 1672c between the embedded vehicle computing system 1640 and a wireless communication device 1612 and/or the computing device on a communication network (e.g., a core network 1632) via the radio module 1640e.

The radio module 1640e may be configured for wireless communication. The radio module 1640e may exchange signals (e.g., command signals for controlling maneuvering, signals from navigation facilities, data signals, etc.) via a communication link 1622 with a network transceiver (e.g., the base station 1610), and may provide the signals to the processor 1640a, 1640g and/or the navigation unit 1672b. In some embodiments, the radio module 1640e may enable the embedded vehicle computing system 1600 to communicate with a wireless communication device 1612 through the wireless communication link 1624. The wireless communication link 1624 may be a bidirectional or unidirectional communication link, and may use one or more communication protocols.

The input module 1640c may receive sensor data from one or more vehicle sensors 1672c as well as electronic signals from other components, including the drive control components 1672a and the navigation components 1672b. The output module 1640d may communicate with or activate various components of the embedded vehicle computing system 1600, including the drive control components 1672a, the navigation components 1672b, and the sensor(s) 1672c.

The control unit 1640 may be coupled to the drive control components 1672a to control physical elements of the vehicle related to maneuvering and navigation of the vehicle, such as the engine, motors, throttles, steering elements, flight control elements, braking or deceleration elements, and the like. The drive control components 1672a may also include components that control other devices of the vehicle, including interior environment controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 1640 may be coupled to the navigation components 1672b, and may receive data from the navigation components 1672b and be configured to use such data to determine the present position and orientation of the vehicle, as well as an appropriate course toward a destination. The navigation components 1672b may include or be coupled to a GNSS receiver system (e.g., one or more Global Positioning System (GPS) receivers) enabling the embedded vehicle computing system 1600 to determine its current position using GNSS signals. Alternatively, or in addition, the navigation components 1672b may include radio navigation receivers for receiving navigation beacons or other signals from radio nodes, such as Wi-Fi access points, cellular network sites, radio station, remote computing devices, other vehicles, etc. Through control of the drive control elements 1672a, the processor 1640a may control the vehicle to navigate and maneuver. The processor 1640a, 1640g and/or the navigation components 1672b may be configured to communicate with a network element such as a server in a communication network (e.g., a core network 1632) via the wireless communication link 1622, 1626 to receive commands to control maneuvering, receive data useful in navigation, provide real-time position reports, etc.

The control unit 1640 may be coupled to one or more sensors 1672c. The sensor(s) 1672c may include the sensors 1642-1670 as described, and may the configured to provide a variety of data to the processor 1640a, 1640g.

While the control unit 1640 is described as including separate components, in some embodiments some or all of the components (e.g., the processor 1640a, the memory 1640b, the input module 1640c, the output module 1640d, and the radio module 1640e) may be integrated in a single device or module, such as a processing system processing device. Such a processing system processing device may be configured for use in vehicles and be configured, such as with processor-executable instructions executing in the processor 1640a, to perform operations of navigation and collision avoidance.

Implementation examples are described in the following paragraphs. While some of the following implementation examples are described in terms of example systems, devices, or methods, further example implementations may include: the example systems or devices discussed in the following paragraphs implemented as a method executing operations of the example systems or devices, the example systems, devices, or methods discussed in the following paragraphs implemented by a computing device comprising a processing device and/or a PCIe controller configured with processing device-executable instructions to perform operations of the example systems, devices, or methods; a PCIe controller configured to perform operations of the example systems, devices, or methods; a computing device comprising a configured to perform operations of the example systems, devices, or methods; the example systems, devices, or methods discussed in the following paragraphs implemented by a computing device including means for performing functions of the example systems, devices, or methods; and the example systems, devices, or methods discussed in the following paragraphs implemented as a non-transitory processor-readable storage medium having stored thereon processor-executable instructions configured to cause a processor of a computing device to perform the operations of the example systems, devices, or methods.

### EXAMPLE

Example 1. A method for managing errors occurring in parts of a universal chiplet interconnect express (UCIe) link for chiplets of a computing device, including: identifying a first part of a UCIe link in which an error has occurred; training the first part of the UCIe link in which the error has occurred; and maintaining active a second part of the UCIe link in which no error has occurred while training the first part of the UCIe link in which the error has occurred.

### EXAMPLE 2

The method of claim 1, in which: the first part of the UCIe link is a sideband; the second part of the UCIe link is a mainband; and identifying the first part of a UCIe link in which the error has occurred includes: identifying a timeout for a sideband message; setting a UCIe link error recovery structure with a value configured to indicate to the computing device an occurrence of the error in the sideband in response to identifying the timeout for the sideband message; and reading the value configured to indicate to the computing device the occurrence of the error in the sideband from the error recovery structure.

### EXAMPLE 3

The method of claim 1, in which: the first part of the UCIe link is a sideband; the second part of the UCIe link is a mainband; training the first part of the UCIe link in which the error has occurred includes: toggling power to the sideband; and transitioning from a sideband initialization state directly to a link initialization state; and maintaining active the second part of the UCIe link in which no error has occurred while training the first part of the UCIe link in which the error has occurred includes maintaining power to the mainband while training the sideband.

### EXAMPLE 4

The method of claim 1, in which: the first part of the UCIe link is a mainband; the second part of the UCIe link is a sideband; and identifying the first part of a UCIe link in which the error has occurred includes: identifying a handshake request for entering an error state; setting a UCIe link error recovery structure with a value configured to indicate to the computing device an occurrence of the error in the mainband in response to identifying the handshake request for entering the error state; and reading the value configured to indicate to the computing device the occurrence of the error in the mainband from the error recovery structure.

### EXAMPLE 5

The method of claim 1, in which: the first part of the UCIe link is a mainband; the second part of the UCIe link is a sideband; and training the first part of the UCIe link in which the error has occurred includes: toggling power to the mainband; and transitioning from a reset state directly to a mainband initialization state; and maintaining active the second part of the UCIe link in which no error has occurred while training the first part of the UCIe link in which the error has occurred includes maintaining power to the sideband while training the mainband.

### EXAMPLE 6

The method of claim 1, in which: the first part of the UCIe link is a mainband and a sideband; the second part of the UCIe link is no part of the UCIe link; and identifying the first part of a UCIe link in which the error has occurred includes: identifying a handshake request for entering an error state; identifying a timeout for a handshake response for entering the error state; setting a UCIe link error recovery structure with a value configured to indicate to the computing device an occurrence of the error in the mainband and the sideband in response to identifying the handshake request and identifying the timeout for the handshake response for entering the error state; and reading the value configured to indicate to the computing device the occurrence of the error in the mainband and the sideband from the error recovery structure.

### EXAMPLE 7

The method of claim 1, in which: the first part of the UCIe link is a mainband and a sideband; the second part of the UCIe link is no part of the UCIe link; and training the first part of the UCIe link in which the error has occurred includes: toggling power to the mainband and to the sideband; and transitioning from a sideband initialization to a mainband initialization state.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method for managing errors occurring in parts of a universal chiplet interconnect express (UCIe) link for chiplets of a computing device, comprising:
identifying a first part of a UCIe link in which an error has occurred;
training the first part of the UCIe link in which the error has occurred; and
maintaining active a second part of the UCIe link in which no error has occurred while training the first part of the UCIe link in which the error has occurred.

2. The method of claim 1, wherein:
the first part of the UCIe link is a sideband;
the second part of the UCIe link is a mainband; and
identifying the first part of a UCIe link in which the error has occurred includes:
identifying a timeout for a sideband message;
setting a UCIe link error recovery structure with a value configured to indicate to the computing device an occurrence of the error in the sideband in response to identifying the timeout for the sideband message; and
reading the value configured to indicate to the computing device the occurrence of the error in the sideband from the error recovery structure.

3. The method of claim 1, wherein:
the first part of the UCIe link is a sideband;
the second part of the UCIe link is a mainband;
training the first part of the UCIe link in which the error has occurred includes:
toggling power to the sideband; and
transitioning from a sideband initialization state directly to a link initialization state; and
maintaining active the second part of the UCIe link in which no error has occurred while training the first part of the UCIe link in which the error has occurred includes maintaining power to the mainband while training the sideband.

4. The method of claim 1, wherein:
the first part of the UCIe link is a mainband;
the second part of the UCIe link is a sideband; and
identifying the first part of a UCIe link in which the error has occurred includes:
identifying a handshake request for entering an error state;
setting a UCIe link error recovery structure with a value configured to indicate to the computing device an occurrence of the error in the mainband in response to identifying the handshake request for entering the error state; and
reading the value configured to indicate to the computing device the occurrence of the error in the mainband from the error recovery structure.

5. The method of claim 1, wherein:
the first part of the UCIe link is a mainband;
the second part of the UCIe link is a sideband;
training the first part of the UCIe link in which the error has occurred includes:
toggling power to the mainband; and
transitioning from a reset state directly to a mainband initialization state; and
maintaining active the second part of the UCIe link in which no error has occurred while training the first part of the UCIe link in which the error has occurred includes maintaining power to the sideband while training the mainband.

6. The method of claim 1, wherein:
the first part of the UCIe link is a mainband and a sideband;
the second part of the UCIe link is no part of the UCIe link; and
identifying the first part of a UCIe link in which the error has occurred includes:
identifying a handshake request for entering an error state;
identifying a timeout for a handshake response for entering the error state;
setting a UCIe link error recovery structure with a value configured to indicate to the computing device an occurrence of the error in the mainband and the sideband in response to identifying the handshake request and identifying the timeout for the handshake response for entering the error state; and
reading the value configured to indicate to the computing device the occurrence of the error in the mainband and the sideband from the error recovery structure.

7. The method of claim 1, wherein:
the first part of the UCIe link is a mainband and a sideband;
the second part of the UCIe link is no part of the UCIe link; and
training the first part of the UCIe link in which the error has occurred includes:
toggling power to the mainband and to the sideband; and
transitioning from a sideband initialization to a mainband initialization state.

8. A computing device, comprising:
at least two chiplets; and
a universal chiplet interconnect express (UCIe) link configuration device coupled to the at least two chiplets and configured to:
identify a first part of a UCIe link between the at least two chiplets in which an error has occurred;
train the first part of the UCIe link in which the error has occurred; and
maintain active a second part of the UCIe link in which no error has occurred while training the first part of the UCIe link in which the error has occurred.

9. The computing device of claim 8, wherein:
the first part of the UCIe link is a sideband;
the second part of the UCIe link is a mainband; and
the UCIe link configuration device is further configured to identify the first part of a UCIe link in which the error has occurred by:
identifying a timeout for a sideband message;
setting a UCIe link error recovery structure with a value configured to indicate to the computing device an occurrence of the error in the sideband in response to identifying the timeout for the sideband message; and
reading the value configured to indicate to the computing device the occurrence of the error in the sideband from the error recovery structure.

10. The computing device of claim 8, wherein:
the first part of the UCIe link is a sideband;
the second part of the UCIe link is a mainband;
the UCIe link configuration device is further configured to train the first part of the UCIe link in which the error has occurred by:
toggling power to the sideband; and
transitioning from a sideband initialization state directly to a link initialization state; and
the UCIe link configuration device is further configured to maintain power to the mainband while training the sideband.

11. The computing device of claim 8, wherein:
the first part of the UCIe link is a mainband;
the second part of the UCIe link is a sideband; and
the UCIe link configuration device is further configured to identify the first part of the UCIe link in which the error has occurred by:
identifying a handshake request for entering an error state;
setting a UCIe link error recovery structure with a value configured to indicate to the computing device an occurrence of the error in the mainband in response to identifying the handshake request for entering the error state; and
reading the value configured to indicate to the computing device the occurrence of the error in the mainband from the error recovery structure.

12. The computing device of claim 8, wherein:
the first part of the UCIe link is a mainband;
the second part of the UCIe link is a sideband; and
the UCIe link configuration device is further configured to train the first part of the UCIe link in which the error has occurred includes:
toggling power to the mainband; and
transitioning from a reset state directly to a mainband initialization state; and
the UCIe link configuration device is further configured to maintain power to the sideband while training the mainband.

13. The computing device of claim 8, wherein:
the first part of the UCIe link is a mainband and a sideband;
the second part of the UCIe link is no part of the UCIe link; and
the UCIe link configuration device is further configured to identify the first part of a UCIe link in which the error has occurred by:
identifying a handshake request for entering an error state;
identifying a timeout for a handshake response for entering the error state;
setting a UCIe link error recovery structure with a value configured to indicate to the computing device an occurrence of the error in the mainband and the sideband in response to identifying the handshake request and identifying the timeout for the handshake response for entering the error state; and
reading the value configured to indicate to the computing device the occurrence of the error in the mainband and the sideband from the error recovery structure.

14. The computing device of claim 8, wherein:
the first part of the UCIe link is a mainband and a sideband,
the second part of the UCIe link is no part of the UCIe link, and
the UCIe link configuration device is further configured to train the first part of the UCIe link in which the error has occurred by:
toggling power to the mainband and to the sideband; and
transitioning from a sideband initialization to a mainband initialization state.

15. A computing device, comprising:
means for identifying a first part of a chiplet interconnect express (UCIe) link in which an error has occurred;
means for training the first part of the UCIe link in which the error has occurred; and
means for maintaining active a second part of the UCIe link in which no error has occurred while training the first part of the UCIe link in which the error has occurred.

16. The computing device of claim 15, wherein:
the first part of the UCIe link is a sideband;
the second part of the UCIe link is a mainband; and
means for identifying the first part of a UCIe link in which the error has occurred comprises: identifying a timeout for a sideband message;
means for setting a UCIe link error recovery structure with a value configured to indicate to the computing device an occurrence of the error in the sideband in response to identifying the timeout for the sideband message; and
means for reading the value configured to indicate to the computing device the occurrence of the error in the sideband from the error recovery structure.

17. The computing device of claim 15, wherein:
the first part of the UCIe link is a sideband;
the second part of the UCIe link is a mainband;
means for training the first part of the UCIe link in which the error has occurred comprises:
means for toggling power to the sideband; and
means for transitioning from a sideband initialization state directly to a link initialization state; and
means for maintaining active the second part of the UCIe link in which no error has occurred while training the first part of the UCIe link in which the error has occurred includes means for maintaining power to the mainband while training the sideband.

18. The computing device of claim 15, wherein:
the first part of the UCIe link is a mainband;
the second part of the UCIe link is a sideband; and
means for identifying the first part of a UCIe link in which the error has occurred comprises:
means for identifying a handshake request for entering an error state;
means for setting a UCIe link error recovery structure with a value configured to indicate to the computing device an occurrence of the error in the mainband in response to identifying the handshake request for entering the error state; and
means for reading the value configured to indicate to the computing device the occurrence of the error in the mainband from the error recovery structure.

19. The computing device of claim 15, wherein:
the first part of the UCIe link is a mainband;
the second part of the UCIe link is a sideband; and
means for training the first part of the UCIe link in which the error has occurred comprises:
means for toggling power to the mainband; and
means for transitioning from a reset state directly to a mainband initialization state; and
means for maintaining active the second part of the UCIe link in which no error has occurred while training the first part of the UCIe link in which the error has occurred includes means for maintaining power to the sideband while training the mainband.

20. The computing device of claim 15, wherein:
the first part of the UCIe link is a mainband and a sideband;
the second part of the UCIe link is no part of the UCIe link; and
means for identifying the first part of a UCIe link in which the error has occurred comprises:
means for identifying a handshake request for entering an error state;
means for identifying a timeout for a handshake response for entering the error state;
means for setting a UCIe link error recovery structure with a value configured to indicate to the computing device an occurrence of the error in the mainband and the sideband in response to identifying the handshake request and identifying the timeout for the handshake response for entering the error state; and
means for reading the value configured to indicate to the computing device the occurrence of the error in the mainband and the sideband from the error recovery structure.

21. The computing device of claim 15, wherein:
the first part of the UCIe link is a mainband and a sideband,
the second part of the UCIe link is no part of the UCIe link, and
means for training the first part of the UCIe link in which the error has occurred comprises:
means for toggling power to the mainband and to the sideband; and
means for transitioning from a sideband initialization to a mainband initialization state.

22. A universal chiplet interconnect express (UCIe) link configuration device for use in a computing device including at least two chiplets, the UCIe link configuration device configured to:
identify a first part of a UCIe link between two chiplets in which an error has occurred;
train the first part of the UCIe link in which the error has occurred; and
maintain active a second part of the UCIe link in which no error has occurred while training the first part of the UCIe link in which the error has occurred.

23. The UCIe link configuration device of claim 22, wherein:
the first part of the UCIe link is a sideband;
the second part of the UCIe link is a mainband; and
the UCIe link configuration device is further configured to identify the first part of a UCIe link in which the error has occurred by:
identifying a timeout for a sideband message;
setting a UCIe link error recovery structure with a value configured to indicate to the computing device an occurrence of the error in the sideband in response to identifying the timeout for the sideband message; and
reading the value configured to indicate to the computing device the occurrence of the error in the sideband from the error recovery structure.

24. The UCIe link configuration device of claim 22, wherein:
the first part of the UCIe link is a sideband;
the second part of the UCIe link is a mainband;
the UCIe link configuration device is further configured to train the first part of the UCIe link in which the error has occurred by:
toggling power to the sideband; and
transitioning from a sideband initialization state directly to a link initialization state; and
the UCIe link configuration device is further configured to maintain power to the mainband while training the sideband.

25. The UCIe link configuration device of claim 22, wherein:
the first part of the UCIe link is a mainband;
the second part of the UCIe link is a sideband; and
the UCIe link configuration device is further configured to identify the first part of the UCIe link in which the error has occurred by:
identifying a handshake request for entering an error state;
setting a UCIe link error recovery structure with a value configured to indicate to the computing device an occurrence of the error in the mainband in response to identifying the handshake request for entering the error state; and
reading the value configured to indicate to the computing device the occurrence of the error in the mainband from the error recovery structure.

26. The UCIe link configuration device of claim 22, wherein:
the first part of the UCIe link is a mainband;
the second part of the UCIe link is a sideband; and
the UCIe link configuration device is further configured to train the first part of the UCIe link in which the error has occurred includes:
toggling power to the mainband; and
transitioning from a reset state directly to a mainband initialization state; and
the UCIe link configuration device is further configured to maintain power to the sideband while training the mainband.

27. The UCIe link configuration device of claim 22, wherein:
the first part of the UCIe link is a mainband and a sideband;
the second part of the UCIe link is no part of the UCIe link; and
the UCIe link configuration device is further configured to identify the first part of a UCIe link in which the error has occurred by:
identifying a handshake request for entering an error state;
identifying a timeout for a handshake response for entering the error state;
setting a UCIe link error recovery structure with a value configured to indicate to the computing device an occurrence of the error in the mainband and the sideband in response to identifying the handshake request and identifying the timeout for the handshake response for entering the error state; and
reading the value configured to indicate to the computing device the occurrence of the error in the mainband and the sideband from the error recovery structure.

28. The UCIe link configuration device of claim 22, wherein:
the first part of the UCIe link is a mainband and a sideband,
the second part of the UCIe link is no part of the UCIe link, and
the UCIe link configuration device is further configured to train the first part of the UCIe link in which the error has occurred by:
toggling power to the mainband and to the sideband; and
transitioning from a sideband initialization to a mainband initialization state.
